(19) United States
(12) Patent Application Publication
(10) Pub. No.: US 2010/0179876 A1
(43) Pub. Date: Jul. 15, 2010

(54) COMPUTER-ACCESSIBLE MEDIUM, METHOD AND SYSTEM FOR ASSISTING IN NAVIGATING THE INTERNET

(76) Inventor: Bjorn Holte, Oslo (NO)

Correspondence Address: DORSEY & WHITNEY LLP;INTELLECTUAL PROPERTY DEPARTMENT, 250 PARK AVENUE, NEW YORK, NY, 10177, US

(21) Appl. No.: 12/598,909

(22) PCT Filed: May 5, 2008
(86) PCT No.: PCT/IB08/03682

§ 371 Date: Mar. 23, 2010

Related U.S. Application Data
(60) Provisional application No. 60/916,276, filed on May 4, 2007.

(51) Int. Cl. G06F 3/01; G06Q 30/00; G06F 3/048

(52) U.S. Cl. 705/14.54; 705/14.69; 715/760; 715/810; 715/854; 715/864

(57) ABSTRACT

A computer-accessible medium, method and system is provided for availing hierarchal menus which can enhance and simplify the navigation of web sites. Such menus may permit improved access to web pages within a web site via a standardized interface that can be displayed as hierarchal menus. Such menus may be provided by receiving a request to browse a web site, obtaining the link structure and/or content of the web site, and generating menu data reflecting the link structure and/or other properties of the web site. The data may optionally be filtered or truncated to limit the size of the navigational menus. Exemplary menus may further be provided with menu items containing advertising links and/or labels within one or more levels. The generation and placement of these exemplary advertisement menu items can be context-sensitive and based, for example, on other menu labels or links.

### FIELD CROSS-REFERENCED TO RELATED APPLICATION(S)

This application is a national stage application of PCT Application No. PCT/IB2008/003682 which was filed on May 5, 2008 and published on Aug. 6, 2009 as International Publication No. WO 2009/050590 (the “International Application”). This application claims priority from the International Application pursuant to 35 U.S.C. §120, and from U.S. Provisional Patent Application No. 60/916,276, filed May 4, 2007, under 35 U.S.C. §119(e). The disclosures of the above-referenced applications are incorporated herein by reference in their entities.

### FIELD OF THE INVENTION

The present invention relates to a computer-accessible medium, method and system which can provide improved navigation of web content within a web site. The present invention further relates to a computer-accessible medium, method and system for providing navigational menus that facilitate access to specific web pages and specific content on web pages located within a web site, without the need to load or browse intermediate or top-level pages in a hierarchy of the site. For example, these exemplary menus can further be provided with menu items containing advertising links and/or labels within one or more levels. The generation and placement of these exemplary advertisement menu items can be context-sensitive and based, for example, on other menu labels or links.

### BACKGROUND INFORMATION

The Internet provides users access to a multitude of web sites. These web sites can be made up of web pages, which may be linked together using a hypertext markup language (“HTML”) code. There is currently no standard procedure for navigating through a web site to pages located at an intermediate or lower level. Different web sites may have different link structures and interfaces. This can make navigating different web sites much more complex and demanding than necessary.

Locating specific menu content on current web sites can be a time-consuming process. The placement of, for example, the contact information within a link structure is not standardized among different web sites, which can require the user to locate it for each individual site.

Navigating to a web page that is several levels deep within a web site can be a time-consuming process. Also, in a conventional site navigation, the total link structure often may not be available from all web pages. Many web sites can require that the navigation begins from the first page of the web site.

Presenting and browsing web content on small-screen devices, such as personal digital assistants (“PDAs”) or mobile phones, using conventional browsers and web page display techniques may be difficult. For example, browsers adapted for small displays such as, e.g., an Opera mini browser, can convert content on a web page into a into a long string of content to fit on the small screen. Viewing such web content may require extensive scrolling. Also, links that are present on the displayed web page may be shown at the top of the small-screen display. Thus, it may also be necessary to scroll past all such links on each page to view the content when using conventional browsers and display devices. Further, it may be difficult to browse web content on such small-screen devices because it may be hard to view and select specific items on the available menus.

PCT Application No. PCT/US06/61622, incorporated herein by reference in its entirety, describes systems and techniques for providing menu-based navigation that addresses many of the deficiencies noted above. However, it may be further desirable to incorporate advertisements into such navigational aids that can be effective and unobtrusive.

Certain sites and services on the Internet can provide advertisements which may be selected based on user input. For example, a search engine may provide advertisements on a web page displaying search results, where the advertisements may be related to one or more of the search terms. Websites containing news articles, information forums, etc., may also generate advertisements to be displayed that are related to certain keywords present on web pages within the site.

Such conventional web-based advertisements, which can include so-called “pay per click” advertising, may often use an analysis of search terms based on search engine logs to match users with relevant advertisements. This can be a time-consuming process and may produce many errors, because the keywords used to generate advertisements often are taken out of context and can have several different meanings. Such techniques can result in many non-relevant advertisements being displayed for a user.

Such advertisements may also be located apart from the content of interest to the user, and/or can require users to interrupt their activity to view or click on such advertisements, which may have a form, e.g., of a pop-up window, a graphic that optionally contains a hyperlink to an advertiser's web page, etc.

Thus, there may be a need to facilitate navigational aids and menus for existing and new web sites, which can improve access to both the specific content and web pages within these sites, and to provide advertising messages and links which may be relevant to the website and/or content being navigated and conveniently seen and/or accessed by a user.

### SUMMARY OF EXEMPLARY EMBODIMENTS OF THE INVENTION

To address the problems and deficiencies described above, computer-accessible mediums, methods and systems are provided for availing hierarchal menus which can enhance and simplify the navigation of web sites, where such menus may include context-sensitive advertisements.

For example, provided is a computer-accessible medium having stored thereon computer executable instructions for displaying one or more menus to assist with navigation of a web site. Using such instructions, a computing arrangement may be specifically configured to (a) receive first information from a client which is associated with the web site; (b) obtain second information relating to a link structure of the web site; (c) provide third information for generating a menu-based structure and/or a hierarchal structure as a function of the second information; and (d) identify and/or separate web page links and web page content associated with the web site. The second information may be generated and/or obtained independently from one or more processors associated with the web site. Further, the menu-based structure and/or the hierarchal structure can comprise a plurality of items.

The menu-based structure and/or a hierarchal structure can include an advertising menu item. The advertising menu item can be generated and/or displayed in a navigational menu. An advertiser can purchase one or more specific keywords or categories which can trigger generation and/or display of their advertisement as the advertising menu item. The advertising menu item can be generated and/or displayed in the navigational menu based on one or more keywords which may be present in a menu label or on the web page for which the navigational menu is being generated and/or displayed. The advertising menu item can be shown in context with the one or more keywords that may be present in, or associated with, the navigational menu.

According to another exemplary embodiment of the present invention, it is possible to identify and provide a relevant advertisement for displaying in a navigational menu. A user can provide a request for what content associated with the web page to load and/or display. The computer-accessible medium may further comprise separating out page content for small-screen browsing, wherein the at least one of a menu-based structure or a hierarchal structure is configured for display on a mobile phone or another small screen device.

A method for displaying one or more menus to assist with navigation of a web site according to still another exemplary embodiment of the present invention can be provided. Using such exemplary method, it is possible to, for example, (a) receive first information from a client which is associated with the web site; (b) obtain second information relating to a link structure of the web site; (c) provide third information for generating a menu-based structure and/or a hierarchal structure as a function of the second information, and; (d) identify and/or separate web page links and web page content associated with the web site. The second information can be generated and/or obtained independently from one or more processors associated with the web site. The menu-based structure and/or the hierarchal structure can comprise a plurality of items. Such menu-based structure and/or a hierarchal structure may include an advertising menu item. An advertising menu item can be generated and/or displayed in a navigational menu based on one or more relevant keywords. For example, an advertiser can purchase one or more specific keywords or categories which can trigger generation and/or display of their advertisement as the advertising menu item. The advertising menu item can be shown in context with the keyword(s) that may be present in, or associated with, the navigational menu.

It is also possible to identify and provide a relevant advertisement for displaying in a navigational menu as well as separating out page content for small-screen browsing. The menu-based structure and/or a hierarchal structure may be configured for display on a mobile phone or another small screen device.

A system for displaying one or more menus to assist with navigation of a web site can also be provided according to an additional exemplary embodiment of the present invention. For example, such system can include a storage arrangement which provides thereon a set of instructions, which when executed by a processing arrangement, may be configured to: (a) receive first information from a client which is associated with the web site; (b) obtain second information relating to a link structure of the web site; (c) provide third information for generating a menu-based structure and/or a hierarchal structure as a function of the second information; and (d) identify and/or separating web page links and web page content associated with the web site. The second information can be generated and/or obtained independently from one or more processors associated with the web site. The menu-based structure and/or the hierarchal structure can comprise a plurality of items. Such menu-based structure and/or a hierarchal structure may include an advertising menu item. An advertising menu item can be generated and/or displayed in a navigational menu based on one or more relevant keywords.

These and other objects, features and advantages of the present invention will become apparent upon reading the following detailed description of embodiments of the invention.

### BRIEF DESCRIPTION OF THE DRAWINGS

Further objects, features and advantages of the invention will become apparent from the following detailed description taken in conjunction with the accompanying Figures showing illustrative embodiments of the invention, in which:

FIG. 1 is a block diagram of an exemplary embodiment of a hierarchal menu-generation system for browsing web sites;

FIG. 2 is a block diagram of a second exemplary embodiment of a hierarchal menu-generation system for browsing web sites;

FIG. 3A is a flow diagram of an exemplary embodiment of a method for generating hierarchal menus for browsing web sites;

FIG. 3B is a flow diagram of a second exemplary embodiment of a method for generating hierarchal menus for browsing web sites;

FIG. 4 is a flow diagram of a third exemplary embodiment of a method for generating hierarchal menus for browsing web sites;

FIG. 5A is a flow diagram of a fourth exemplary embodiment of a method for generating hierarchal menus for browsing web sites;

FIG. 5B is a flow diagram of a fifth exemplary embodiment of a method for generating hierarchal menus for browsing web sites;

FIG. 5C is a flow diagram of a sixth exemplary embodiment of a method for generating hierarchal menus for browsing web sites;

FIG. 5D is a flow diagram of a seventh exemplary embodiment of a method for generating hierarchal menus for browsing web sites;

FIG. 5E is a flow diagram of an eighth exemplary embodiment of a method for generating hierarchal menus for browsing web sites;

FIG. 5F is a flow diagram of a ninth exemplary embodiment of a method for generating hierarchal menus for browsing web sites;

FIG. 6A is a hierarchal diagram of an exemplary link structure of a web site;

FIG. 6B is a hierarchal diagram of an exemplary filtered link structure of a web site;

FIG. 7A is an exemplary listing of source code for a first exemplary web page of the web site, provided with the associated web page;

FIG. 7B is an exemplary listing of source code for a second exemplary web page of the web site, provided with the associated web page;

FIG. 7C is an exemplary listing of source code for a third exemplary web page of the web site, provided with the associated web page;

FIG. 7D is an exemplary listing of source code for a fourth exemplary web page of the web site, provided with the associated web page;

FIG. 8A is an illustration of an exemplary menu structure corresponding to the exemplary web pages shown in FIG. 7A-7D;

FIG. 8B is an illustration of the menu structure of FIG. 8A with particular elements being highlighted;

FIG. 9A is an illustration of an exemplary main menu bar for an exemplary web page;

FIG. 9B is an illustration of exemplary submenus associated with the main menu bar shown in FIG. 9A;

FIG. 10A is a screenshot of an exemplary web page showing the use of hierarchal navigational menus;

FIG. 10B is a screenshot of a second exemplary web page showing further use of hierarchal navigational menus;

FIG. 11 is a flow diagram of a tenth exemplary embodiment of a method for generating hierarchal menus for browsing web sites;

FIG. 12 is a flow diagram of an eleventh exemplary embodiment of a method for generating hierarchal menus for browsing web sites;

FIG. 13 is a flow diagram of a twelfth exemplary embodiment of a method for generating hierarchal menus for browsing web sites;

FIG. 14 is a flow diagram of a thirteenth exemplary embodiment of a method for generating hierarchal menus for browsing web sites;

FIG. 15A is a representation of a first exemplary web page of an exemplary web site, shown together with a listing of associated source code;

FIG. 15B is a representation of a second exemplary web page of an exemplary web site, shown together with a listing of associated source code;

FIG. 16A is an illustration of an exemplary menu structure corresponding to processed page links from the exemplary web pages shown in FIGS. 15A and 15B;

FIG. 16B is an illustration of a further menu structure corresponding to the processed page links from the exemplary web pages shown in FIGS. 15A and 15B;

FIG. 16C is an illustration of a still further exemplary menu structure corresponding to the exemplary web page shown in FIG. 15A;

FIG. 17A is an illustration of an exemplary web page content corresponding to the exemplary web page shown in FIG. 15A; and

FIG. 17B is an illustration of an exemplary web page content corresponding to the exemplary web page shown in FIG. 15B.

FIG. 18 is a flow diagram of an exemplary embodiment of a method according to the present invention;

FIG. 19 is a diagram of an exemplary menu containing an advertisement in accordance with an exemplary embodiment of the present invention;

FIG. 20 is a flow diagram of a second exemplary method in accordance with an exemplary embodiment of the present invention;

FIG. 21 is a flow diagram of a third exemplary method in accordance with an exemplary embodiment of the present invention;

FIG. 22 is a flow diagram of a fourth exemplary method in accordance with an exemplary embodiment of the present invention;

FIG. 23A is an illustration of an exemplary menu structure containing advertising in accordance with an exemplary embodiment of the present invention;

FIG. 23B is an illustration of a further exemplary menu structure with advertising in accordance with an exemplary embodiment of the present invention;

FIG. 23C is an illustration of a yet further exemplary menu structure with advertising in accordance with an exemplary embodiment of the present invention;

FIG. 24 is an illustration of an exemplary interface which may be used to select advertisements in accordance with an exemplary embodiment of the present invention;

FIG. 25A is a screenshot of an exemplary hierarchal menu containing advertising in accordance with an exemplary embodiment of the present invention; and

FIG. 25B is a screenshot of a further exemplary hierarchal menu containing advertising in accordance with an exemplary embodiment of the present invention.

Throughout the figures, the same reference numerals and characters, unless otherwise stated, are used to denote like features, elements, components or portions of the illustrated embodiments. Moreover, while the subject invention will now be described in detail with reference to the figures, it is done so in connection with the illustrative embodiments. It is intended that changes and modifications can be made to the described embodiments without departing from the true scope and spirit of the subject invention as defined by the appended claims.

### DETAILED DESCRIPTION OF EXEMPLARY EMBODIMENTS OF THE INVENTION

The exemplary embodiments of the computer-accessible medium, method and system according to the present invention can be implemented using the following exemplary arrangements, techniques and procedures. Menu-based advertisements can be provided, for example, using the systems and methods for generating and displaying hierarchal menus as described, e.g., in PCT Application No. PCT/US06/61622 (e.g., the “bMenu” system and method).

Advertisements may be provided, for example, as menu items having labels and/or links which may be generated or selected for inclusion in menus based on keywords that may be present in the menus themselves, in web page labels, etc.

Keywords which can be used, for example, to generate and display certain providers' advertisements in menus can be specific such as, e.g., ‘basketball,’ or they can include broader categories such as, e.g., ‘sports.’ Providers can be charged different rates based on the generality or specificity of keywords selected to display their advertisements as menu items.

Context-based menu advertisements can also be provided for small-screen devices such as, for example, cell phones or personal digital assistants (“PDAs”). Such menu-item advertisements can be less obtrusive than advertisements which are displayed, for example, on web pages themselves, and thus may have to be scrolled past or otherwise bypassed for a user to access other content on the web page.

According to certain exemplary embodiments of the present invention, computer-accessible medium, method and system can be provided for generating contextual advertisements in a drop-down menu interface for existing web sites, for example. This exemplary menu interface may be hierarchal. The exemplary embodiment of bMenu described herein can detect all or part of the web page hierarchy and structure of the particular web site, and may convert this into menu data. The menu data can be stored in a central database and accessed or made available when requested from a client computer. The client computer and web browser operating thereon can convert this menu data to a dropdown menu interface, thus enabling a user to navigate the web site with a menu. Keywords which may be present on the web page and/or used to generate the menus can be used to generate advertisements having a form of menu items.

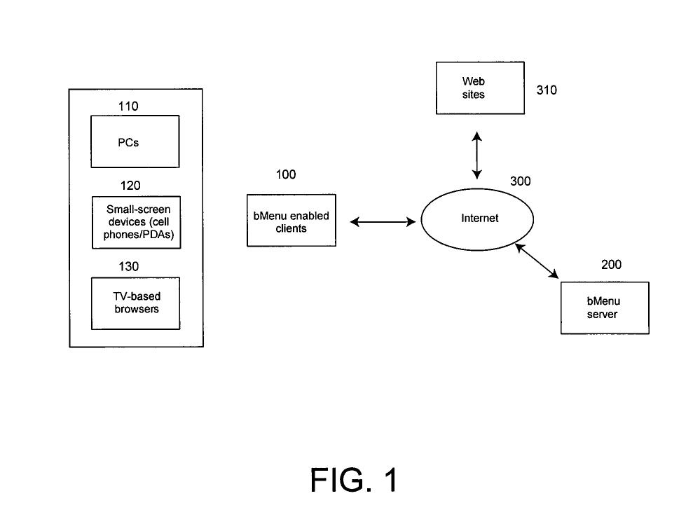

FIG. 1 shows a block diagram of an exemplary system that can be configured to access Internet content. In this embodiment, an exemplary bMenu-enabled client (“client”) 100 may be configured to communicate with web sites 310 (which may be located on various web servers) through a bMenu server (“server”) 200 via the Internet 300. The web sites 310 may also be provided on, and accessed via, an intranet. The client 100 may include, but is not limited to, a personal computer (“PC”) 110, a personal digital assistant (“PDA”) 120, a television-based web browser (“TV browser”) 130, etc.

The client 100 may provide a uniform resource locator (“URL”) or other information capable of identifying the web site 310 (which the client 100 may be browsing or accessing) to the server 200. The server 200 may respond by providing menu data for the requested web site to the client 100 if it is available on the server 200. The client 100 can then use the menu data to generate and display a navigational menu, and may enable the user utilizing the client to navigate the content of the web site 310 by selecting menu items within the navigational menu. Such system can also be configured such that both the client 100 and the server 200 may be executed on the same computer.

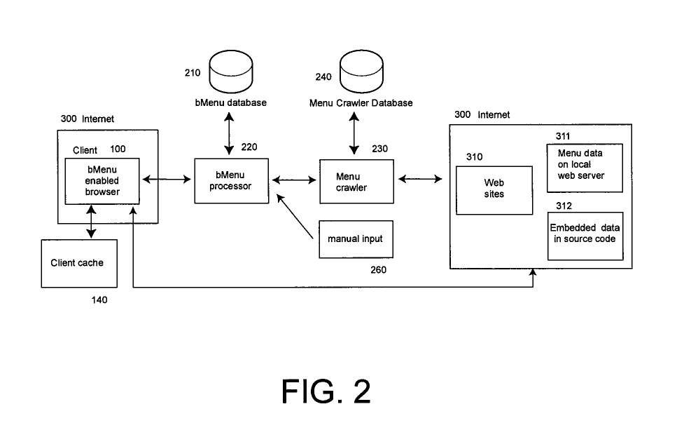

Another exemplary menu-generating system is shown as a block diagram in FIG. 2. In this exemplary embodiment, the system comprises four modules. For example, the client 100, the bMenu database 210, the bMenu processor (“processor”) 220, and the bMenu crawler (“crawler”) 230, which may be in communication with a crawler database 240.

The crawler 230 may comprise a standard program or software arrangement stored in memory or another storage arrangement (e.g., hard drive, flash drive, CD-ROM, etc.) which, when run, can configure an associated processor, which may be the bMenu processor 220, to access and/or read Internet- or web-based content 300 by following links on web pages that it accesses. The crawler 230 can be programmed or, alternatively, obtained as an existing software package.

The crawler 230 can configure the processor 220 or, alternatively, a different processor, to “crawl” a web site (e.g., browse or access web pages, optionally without direct supervision or control by a user or a system administrator) for links located on web pages within the site, and detect the link structure of the web site. The link structure of a web site can relate to the links associated with web pages within the web site, which may comprise URLs that identify other web pages within the web site, and the interrelated structure and/or hierarchy of these links.

The crawler 230 can also detect menu data that may optionally be located on a local web server 311 and/or embedded in source code 312 of the web page. The menu data provided on or accessed by a local web server can be placed in a file at root level, e.g., similarly to the way that conventional robot.txt files may be associated with web pages and provided for search engine crawlers. The file containing such menu data may be assigned a predetermined name that can be recognized by the crawler 230 such as, e.g., bMenu.txt. Menu data optionally embedded in the source code of the web site can be provided, e.g., in the form of individual links or as a menu structure of the entire web site, and may be included in the first or main page of the web site. The menu data can be identified by a predetermined tag which may be recognized by the crawler 230 such as, e.g., <bMenu>.

The “link rel” code, which may be implemented by some existing web sites, can represent an example of this type of embedded data coding. However, <link rel> tags generally provide one level of menus, and it is possible that they may not include hierarchal information that can permit generation of a hierarchal menu scheme.

The URL of the web site that the crawler 230 accesses may be located in a crawler database 240. The crawler database 240 can contain a record for each URL accessed by the crawler 230, where the record can include information such as, e.g., a date that the site was most recently accessed or crawled, which may be used by the crawler 220 to keep the crawler database 240 updated, and which can further reduce or eliminate dead and/or duplicate links.

For example, the crawler 230 can communicate via the Internet 300 to crawl or access the web site 310, send the link structure obtained therein to the processor 220, and then receive additional URLs from processor 220 to crawl. The URLs and corresponding link structures thus obtained may be stored in the crawler database 240.

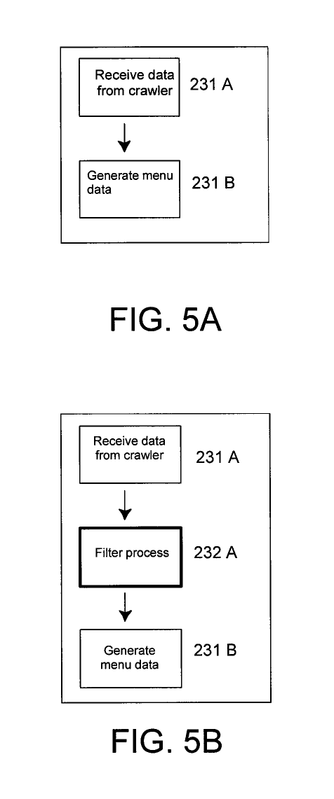

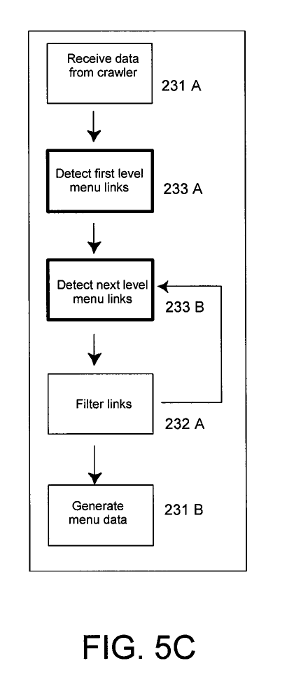

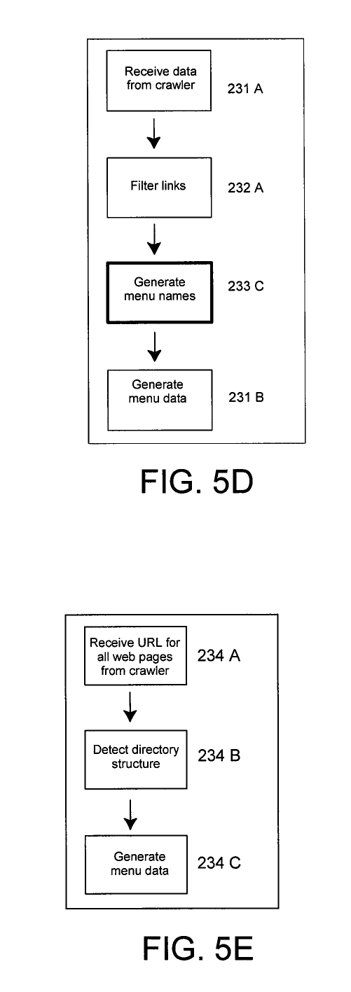

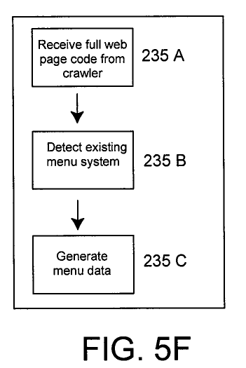

The processor 220 can be configured to process information obtained from the crawler 230, and utilize that information to generate the menu data. The menu data may then be stored in the bMenu database 210. Optionally, the crawler database 240 and the bMenu database 210 may be stored on the same server. Exemplary flow diagrams of exemplary process and methods for generating the menu data are shown in FIGS. 5A-5E, which are described below in further detail.

In certain exemplary embodiments of the exemplary bMenu menu-generating technique, the processor 220 may also handle requests for receipt and/or generation of the menu data from the client 100 and can respond to these requests by providing the menu data obtained from the bMenu database 210. When there is no menu data available for the requested web site on bMenu database 210, a message or instruction may be transmitted to the crawler 230 to crawl or access the web site to obtain the link structure or other information from the web site, which may be used to generate the menu data. The processor 220 can also be configured to receive preprocessed menu data either directly or indirectly via a manual input 260.

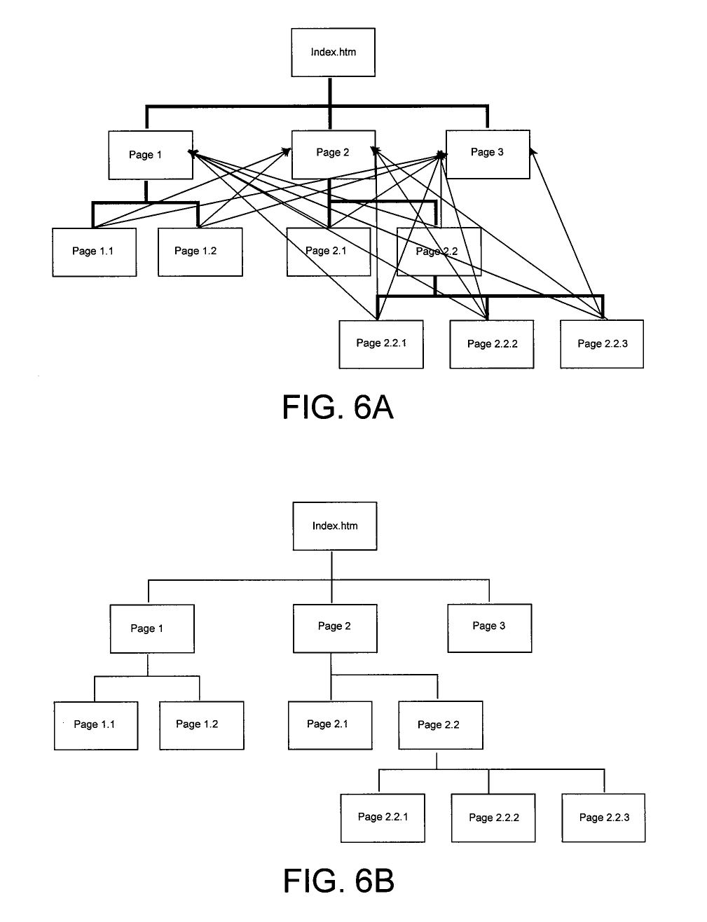

The menu data may comprise, but is not limited to, the menu structure of the web site. The menu data may comprise individual menu components, and it can be presented in several ways. For example, each menu component within the menu data may have a specific name or label to identify it. A menu component that is configured to lead or direct to the web page or location within the web site may further comprise an URL or a link. The menu data may further comprise tagging or listing information that is capable of defining a hierarchal structure, which can be converted to a hierarchal menu that may be displayed or accessed by the client 100. A listing of exemplary menu data that may be generated for the exemplary web site link structure shown in FIGS. 6A and 6B can be as follows:

```
<bMenu>
<menu name=“Menu 1” url=“page1.htm”>
      <link url=“page11.htm”>Menu 1.1</link>
      <link url=“page12.htm”>Menu 1.2</link>
</menu>
<menu name=“Menu 2” url=“page2.htm”>
      <link url=“page21.htm”>Menu 2.1</link>
      <menu name=“Menu 2.2” url=“page22.htm”>
            <link url=“page221.htm”>Menu 2.2.1</link>
            <link url=“page222.htm”>Menu 2.2.2</link>
            <link url=“page223.htm”>Menu 2.2.3</link>
      </menu>
</menu>
<menu name=“Menu 3” url=“page3.htm”>
</menu>
</”bMenu”>
```

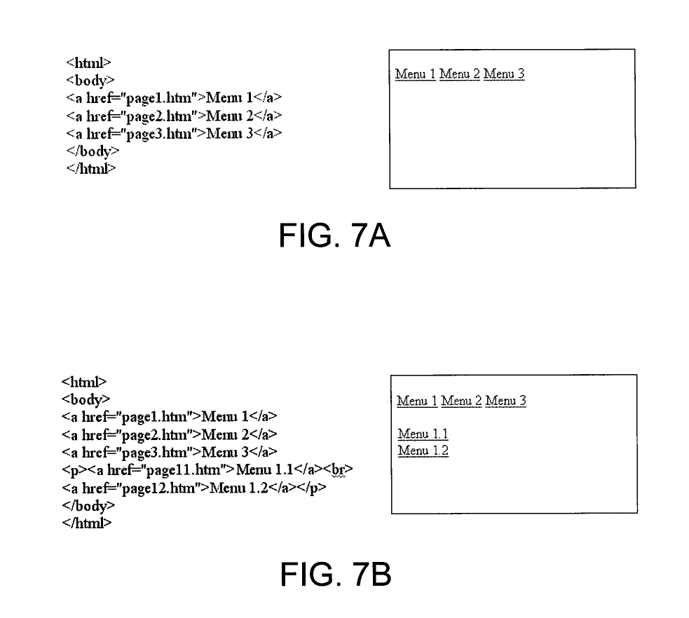

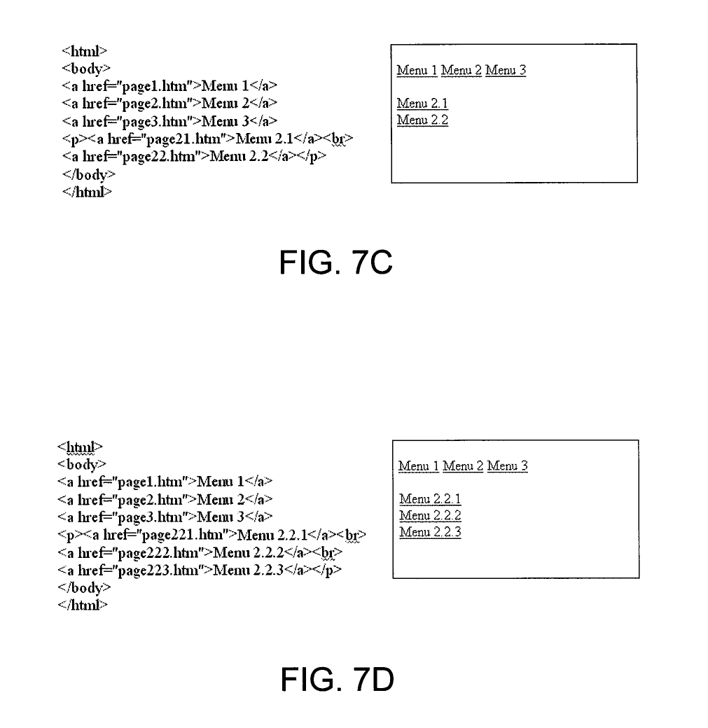

Exemplary HTML code describing the web site, together with the appearance of corresponding web pages generated by the code, is shown in FIGS. 7A-7D.

The bMenu database 210 may be used for storing the menu data. The bMenu database 210 can store the data as plain text and/or utilize conventional database software to make the storage and handling of the menu data more efficient. The menu data stored on the bMenu database 210 can be provided and/or accessed by the processor 220.

The client 100 may be a web browser that is capable of requesting and receiving the menu data received from the processor 220. The client 100 may include, but is not limited to, a browser application accessed via a personal computer, a TV-based browser that can display web content on a television, or a device comprising a software application and a display that can be configured to access and/or browse web content, such as a mobile phone or a PDA. Conventional browser software applications may include Microsoft's Internet Explorer, Netscape, Firefox, Opera or the like.

Existing browsers or other software applications may be enabled to operate or integrate with the exemplary embodiments of the bMenu system by implementing native support for bMenu within the browser software code with the use of client-side scripting, and/or by the use of a software component running separately on the client 100. The software component may include a bar which can be displayed at the top of a browser window, such as the search bar provided by Google or Yahoo! Implementing native support can mean that the exemplary embodiments of the bMenu system may be integrated as parts of the browser's software application. The software component that may be configured to display and use the menu data can be programmed, for example, in C++, Java, Visual Basic, Delphi, .NET, etc. The choice of a computer language to use can depend on the browser and the operating system. For example, it may only be possible to use .NET to implement the exemplary bMenu system into the Microsoft Explorer web browser.

To enhance performance, the client 100 may locally store the menu data associated with frequently accessed web sites. The client 100 may search a cache 140 for the menu data and retrieve such data, if present, rather than sending a request to retrieve web site information by crawling the web site, and generate the menu data. The cached menu data may also have a date or other marker associated with it, which may be compared to data associated with the web site itself to determine if the cached data is current or outdated. If the cached data is determined to be outdated, e.g., because the web site has been modified since the cached data was obtained, then current menu data can be obtained by crawling or accessing the web site again as described above, and such new menu data may be stored on the cache 140.

The client 100 can optionally identify and use the menu data 311 that may be stored on a server hosting the web site 310. The menu data 311, if present, may be retrieved by the crawler 230, and supplied to the processor 220. Alternatively, the menu data 311 associated with a particular web site may be provided by a third party as a preconfigured data file. The webmaster or owner of the web site can create a file containing the menu data 311, and associate the file with the web site 310 on the server hosting the web site. If the optional local menu data 311 is detected by the crawler 230 when accessing the web site, the data can be retrieved and displayed as described above. Alternatively, the client 100 may provide a request to the crawler 230 to locate and retrieve the menu data 311 embedded in the source code 312 of the web site, if present.

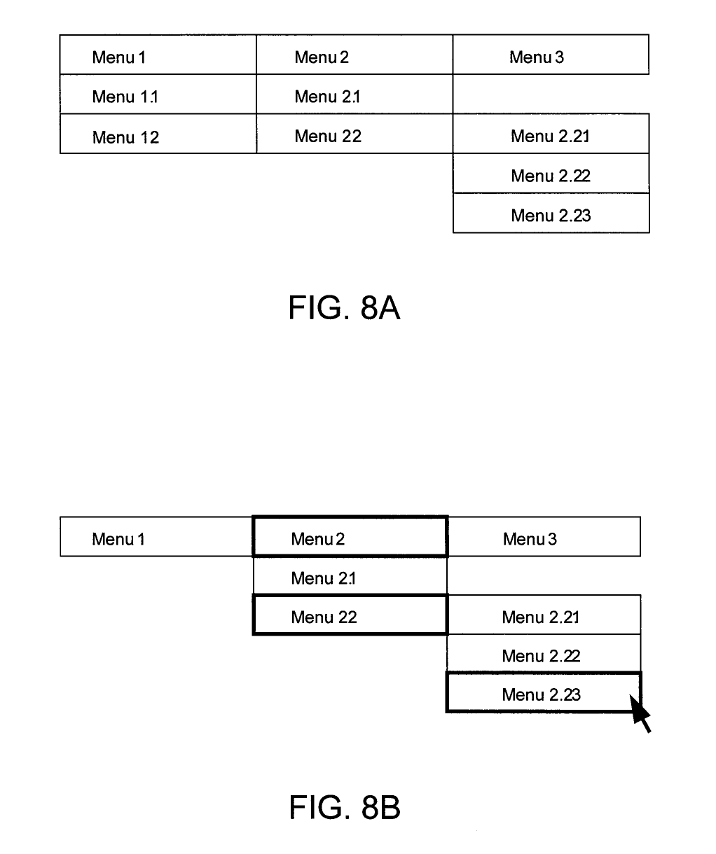

In certain exemplary menu-generating systems described herein, the menu data may be displayed via an interface comprising drop-down menus, and such menus may optionally be hierarchal. The drop-down menus can enable a user to navigate the web site in a conventional and familiar manner. FIG. 8A shows an exemplary drop-down menu structure generated by the exemplary XML code described above, which corresponds to the exemplary filtered link structure shown in FIG. 6B. FIG. 8B shows the display and selection of hierarchal menus using the menu structure of FIG. 8A.

A manual input 250 may also be used to provide menu data directly to the processor 220. The manual input can be performed, e.g., by using a menu editor or other software program structured to order or arrange the links located within the web site. The manual input can be provided, e.g., in the form of a file containing the menu data or as a data feed or stream that can serve as input to the database 210.

The crawler 230 may be configured to access and identify certain content of a web site by following the link structure contained therein. The links structures can be transmitted to the processor 220, and may be processed and converted to the menu data. The processor 220 can use different methods and/or procedures for generating menu data, which may depend on the structure and the content of the web site. The crawler 230 may also be configured to detect the existing link structure, filter it for duplicates, and convert this information into the menu data, which may then be stored in the bMenu database 210. The client 100 may be configured to transmit a request for the menu data to the processor 220 each time the user requests access to an URL via the browser. The processor 220 may then access the bMenu database 210 to search for menu data associated with the requested URL, retrieve the menu data if located, and provide it to the client 100. If the requested menu data is not available on the bMenu database 210, the processor 220 can provide the URL of the web site to the crawler 230, and the crawler 230 can then access or crawl the web site associated with the URL to retrieve the site's link structure and generate the menu data, as described above. The URL and information retrieved from the corresponding web site by the crawler 230 may be stored in the crawler database 240.

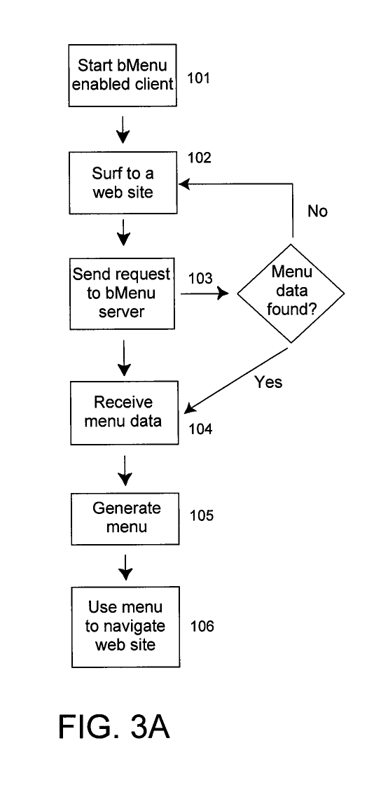

A flow diagram of a method for generating menus is shown in FIG. 3A. This exemplary diagram shows exemplary steps that may be used to access and use navigational web page menus. For example, a user may access the bMenu system by starting a bMenu-enabled client (step 101). The client may be a browser which is configured to access and display content located on the Internet. The user may then browse the web site (step 102), and the bMenu-enabled client can then transmit a request to the bMenu server 200 for the menu data associated with the URL of the web site that the user is browsing (step 103). If the requested menu data is not available on the bMenu server 200, then the user may continue browsing without loading the navigational menus (step 102). If menu data corresponding to the requested URL is located, then the bMenu server 200 may transmit the menu data to the bMenu-enabled client, which can be configured to receive the menu data (step 104).

After the bMenu-enabled client receives data from the bMenu server 200, a menu may be generated (step 105) and displayed by the client. An exemplary generated menu is shown in FIGS. 8A and 8B. FIG. 8A shows the complete hierarchal menu tree structure associated with the exemplary menu data provided above. FIG. 8B illustrates an exemplary use of the generated hierarchal menus to navigate the web site. In this exemplary menu, the user selected the menu item labeled Menu 2.2, which is a sub-menu item linked to the menu item labeled Menu 2, and has further selected the sub-menu item labeled Menu 2.2.3, which may comprise a link to the corresponding web page entitled “page223” in the code. The user may navigate directly to the web page entitled “page223” within the web site by, for example, clicking and releasing on the menu item labeled Menu 2.2.3 as shown in FIG. 8B (step 106). By using this exemplary navigational menu, the user can directly access the web page associated with the menu item labeled Menu 2.2.3 without having to load, browse or access the intermediate web pages associated with the menu items labeled Menu 2 and/or Menu 2.2. The navigation of the web site may further be performed in this manner without using existing menus or links provided by the web site.

A flow diagram of a further embodiment of a menu-generating method is shown in FIG. 3B, which illustrates exemplary steps that can provide navigational menus which may be used to access the web pages directly. This exemplary embodiment provides a sequence of steps that includes checking various sources for requested menu data (step 103B), and accessing this menu data if it is available.

A bMenu-enabled client can search for menu data (step 103B) in a client cache 140, on a local web server 311, or in source code 112 of the web site being accessed. If the menu data is located in any of these locations, it can be compared with menu data that may be stored on a bMenu server 200, the most recent data may be provided to the bMenu-enabled client, and navigational menus based on the current data may then be generated (step 105). If it is not possible, for whatever reason, to determine the most recent version of the menu data found, then the size of the menu data fields may be used. For example, the larger data file may optionally be selected and used to generate menus, based on the assumption that the web site may grow in size and have more web menu data as time passes. Alternatively, the data located on the bMenu server 200 can be selected as a default option. The order of priority for selecting which set of menu data to use can also be predetermined by an administrator of the web site or server.

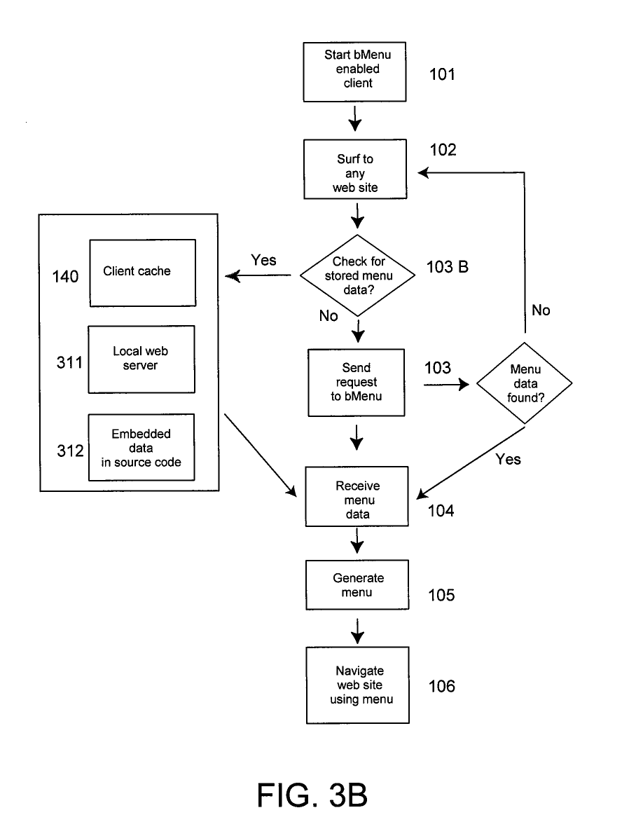

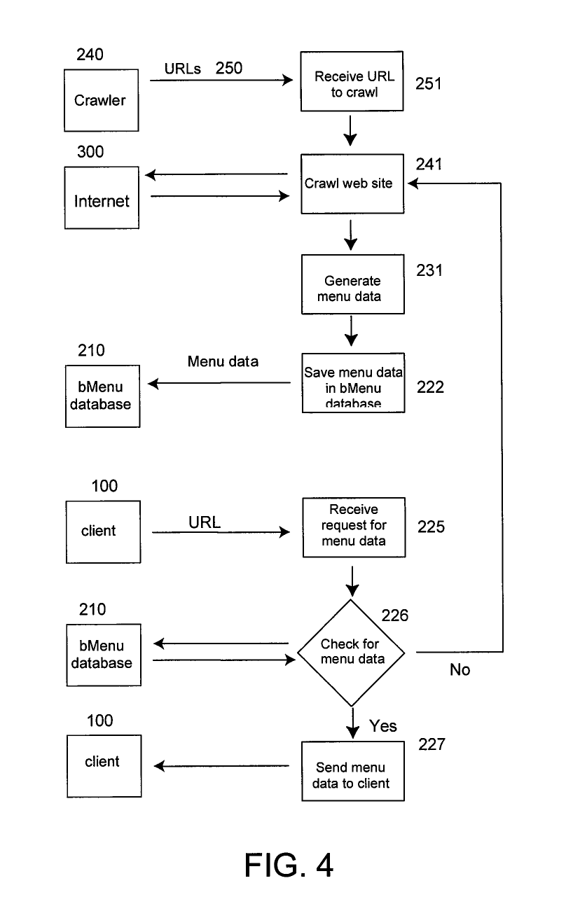

A flow diagram of a still further menu-generating method is shown in FIG. 4, which shows exemplary procedures that may be used by a server to provide navigational web page menus. The crawler can receive an URL identifying a web site to crawl or access (step 251) from a crawler database 250. The crawler can then crawl or access the web site (step 241) which may be accessed via the Internet 300. The amount of data obtained by the crawler may depend on the structure and content of the web site. Preferably, only the link structure of the web site can be retrieved and sent to a processor, such as the bMenu processor 220. Optionally, a greater amount of information or the entire content of certain web sites may be sent to the bMenu processor 220 and/or to another processor.

The bMenu processor 220 may then generate the menu data (step 231) based on the data received from the crawler. The menu data can then be recorded in a bMenu database 210 (step 222), where it may be made available upon request from the client 100. A request for menu data may comprise an URL of a web site that the user is browsing via the client 100. The processor can receive the menu data request from a client 100 (step 225), and then query the bMenu database 210 (step 228) to determine if the requested menu data is stored therein. If the requested menu data is not available in the bMenu database 210, the URL may be provided to the crawler, and the crawler can then crawl or access the web site (step 241) to obtain the requested menu data. If the requested menu data is located in the bMenu database 210, the menu data can be retrieved by the processor and provided to the client 100 (step 227).

FIGS. 5A-5F illustrate certain exemplary embodiments of processes that allow generation of a tree structure of the menu data. Several procedures may be employed to generate the tree structure of the menu data. A first exemplary approach, shown in FIGS. 5A-5C, can comprise using links detected within the web site to generate the navigational menu. FIG. 5D shows an exemplary process for generating menu labels for each link and associated menu item. A second exemplary approach, shown in FIG. 5E, can comprise locating and utilizing a catalog structure of the web site as the menu structure of the web site. A third exemplary approach, shown in FIG. 5F, can comprise detecting and utilizing an existing menu system that may be found on the web site.

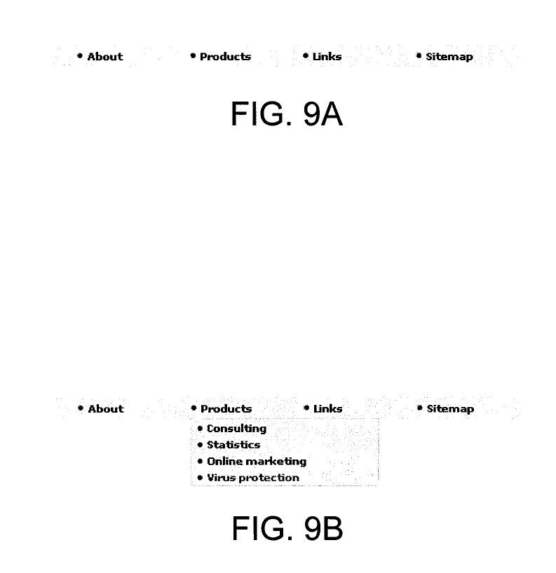

In the exemplary menu data generation process shown in FIG. 5A, the processor receives a link structure associated with the web site from the crawler (step 231A). The link structure may comprise the links located within the web site, which may be presented as a tree structure comprising the pages that the links occur on. The link structure may further comprise the linking relationships between pages, which can specify the target page associated with each link within the web site. To detect the link structure, the crawler may crawl or access some or all links within the web site domain, and can ignore links which already have been detected and/or those which lead to pages outside of the web site (e.g., “external” links). The processor can then generate the menu data based on the link structure (step 231B). Some or all of the links present on the first or main web page of the web site may be configured as top-level links, which may be visible directly in a menu bar or other menu displayed by a client. Examples of such top-level menu items can include the items labeled Menu 1, Menu 2, and Menu 3 in the exemplary menu structure shown in FIG. 9A.

An exemplary web site link structure is shown in FIG. 6A. In this example, only the HTML code of four of the web pages containing new links may be needed to generate the menu data for the entire web site. These four pages are labeled Index.htm, Page 1, Page 2, and Page 2.2 as shown in FIG. 6A. FIGS. 7A-7C show an exemplary HTML code that may be used to generate these four pages, including the URL links that form the link structure shown in FIG. 6A. FIGS. 7A-7D also show the exemplary web pages associated with the exemplary HTML code. The web pages shown in FIGS. 7A-7D contain links to other pages within the web site, consistent with the link structure shown ion FIG. 6A.

The exemplary index page shown in FIG. 7A may comprise three links, labeled Menu 1, Menu 2 and Menu 3, together with the URLs of the web pages associated with these links. These three links may be configured as top-level links because they are on the first page of the web site. Page 1, shown in FIG. 7B, may comprise five links as shown in the source code. These links are labeled Menu 1, Menu 2, Menu 3, Menu 1.1 and Menu 1.2. Page 1 may further comprise the URLs associated with the web pages corresponding to these links. These exemplary links can be configured as second-level links, because they are links located on a page that can be accessed via a top-level link.

The generated menu data can be presented in several ways. An exemplary format of the generated data is shown in FIGS. 8A and 8B, and in the code provided above. Each line of the exemplary XML code provided above may contain a menu component together with a name or menu label, together with the URL of a corresponding web page. If the web page associated with the menu component comprises a link to a second page or location, a lower-level menu component may be associated with the second web page. The menu components may be listed or tagged in an appropriate structure to facilitate creation of a corresponding hierarchal menu structure, such as the exemplary structure shown in FIG. 8A.

Certain exemplary menu items may be repeated on several menu levels because the menus containing these menu items may be available on several pages within the web site. An example of a menu item appearing on several pages within a web site may be a menu item in the main menu of the site, because the main menu may be provided on several or all pages within the web site. Alternatively, there may be links to a particular web page stored within or by the web site that are provided on a plurality of other web pages at various levels within the site.

The menu structure generated from the link structure of the web site can be simplified by the use of an exemplary filter procedure, such as that shown in FIG. 5B. In this exemplary procedure, a processor may receive link structure data associated with a web site from a crawler (step 231A). The menu structure can then be filtered to reduce or eliminate multiple occurrences of links within the menu data (step 232A). The filter process can be performed in a hierarchal manner by deleting the links on the lower menu levels if they can be located on a higher menu level of the web site menu structure, where a higher menu level can be understood to refer to a menu level that can be accessed through fewer connected links starting from the top-level or main menu. For example, the menu item labeled Menu 2.2 in FIG. 8B can be considered a second-level menu item that is situated one level below the main menu item labeled Menu 2, whereas the menu item labeled Menu 2.2.1 can be considered as a third-level menu item because it is situated two levels below the main menu item labeled Menu 2 and one level below the second-level menu item labeled Menu 2.2. Alternatively, when the crawler detects a web page that has already been accessed on the web site, it can associate the page within the link structure at a position that will have the shortest path to the top-level links. The processor can then generate menu data based on the filtered link structure (step 231B).

The link structure of a web site may be viewed as a network of nodes, where every page may be considered as a node and every link can be considered as a way to travel or have access from one node to another. An exemplary node structure corresponding to a web site is shown in FIGS. 6A and 6B, where the rectangular web pages can represent nodes, and the arrows and black lines connecting them can represent links. The link between any two connected nodes may be one-directional, unless two pages each contain a direct link to the other. Each link may be considered to have a unit length. For example, the shortest path calculated between two nodes may be used to determine where in the link structure the pages or nodes may be located, and a page or node may be placed in a position that provides the shortest path to the top level. If a specific web page has two or more different paths to the main or top-level web page that are of equal length, then all but one path can be discarded when filtering the menu data, or duplicate links to the page may be allowed. External links that connect to other web sites may be discarded when generating the menu data. Alternatively, some or all links to one or more external web sites may be included in the menu data of a given web site if desired.

The link structure of an exemplary web site is shown in FIG. 6A, where the dark lines and the arrows can represent links between web pages. The arrows in FIG. 6A can indicate that the top level menu structure, comprising links to Page 1, Page 2 and Page 3, may be available from all web pages. These arrows may be considered to be secondary or back links. The exemplary filter process can detect these secondary links and may delete them to simplify the generated menu structure. The result of the filtering process may then be represented by the exemplary menu structure shown in FIG. 6B.

This exemplary filtering process may be described in more detailed with reference to the source code of the four web pages shown in FIGS. 7A-7D. For example, when the links on Page 1 in FIG. 7B. are filtered, menu data corresponding to the links Menu 1, Menu 2, and Menu 3 (which are links to Page 1, Page 2, and Page 3, respectively) can be deleted because those links may have already been detected on the Index.HTML page shown in FIG. 7A. The links labeled Menu 1.1 and Menu 1.2 (which are links to Page 1.1 and Page 1.2, respectively) may be retained in the generated and filtered menu data. In a similar manner, the links labeled Menu 2.1 and Menu 2.2 may be retained in the menu data as menu items and links associated with the exemplary web page labeled Page 2, shown in FIG. 7C. These links can be the second-level menus under the Menu 2 menu item, and they may also be stored as the second-level links for this exemplary web site, because they are located at the second level of menu links, below the Menu 2 link located at the first or top level. The web page labeled Page 2.2, shown in FIG. 7D, can include HTML code that contains links to Page 1, Page 2, Page 3, Page 2.2.1, Page 2.2.2, and Page 2.2.3. The links to Page 2.2.1, Page 2.2.2, and Page 2.2.3 may be placed in the menu data at a third level, because these pages are located one level below Page 2.2, which may be considered to be a second-level page. During the exemplary filtering process, the links associated with Menu 1, Menu 2 and Menu 3 may be deleted from the link structure directly associated with Page 2.2, and data associated with menu items Menu 2.2.1, Menu 2.2.2 and Menu 2.2.3 may be retained and stored as third-level links.

The code provided above shows an exemplary set of menu data generated from the web site link structure shown in FIG. 6A, after duplicate links and back links have been deleted by the exemplary filtering process described above.

A graphical block diagram illustration of an exemplary embodiment of a complete menu structure generated for the exemplary web site link structure of FIG. 6A is shown in FIG. 9A. The top-level menu may comprise the menu items labeled Menu 1, Menu 2 and Menu 3, and can include links from the Index.htm page to Page 1, Page 2 and Page 3, respectively. The menu item labeled Menu 1.1 can contain a link from Page 1 to Page 1.1, and the other menu items shown in FIG. 9A may contain similar links to the appropriate web pages shown in FIG. 6A.

FIG. 8B shows an exemplary block diagram of the menu data described above as it may appear while being displayed and used via a client. The black arrow may represent a cursor or other pointing indicator that can interact with the browser or other web content display on the client. Placing the cursor over the menu item labeled Menu 2 in the top-level menu can reveal the lower-level menu items labeled Menu 2.1 and Menu 2.2. The user may then move the cursor over the lower-level menu item labeled Menu 2.2, which may then reveal the next set of lower-level menu items labeled Menu 2.2.1, Menu 2.2.2, and Menu 2.2.3. The user may then move the cursor over the now-revealed menu item labeled Menu 2.2.3 and, by clicking a mouse button or performing another appropriate selection action while the cursor is pointing to this menu item, the user may activate the link associated with this menu item and navigate directly to Page 2.2.3. This process allows the user to navigate, e.g., directly to Page 2.2.3 and view its contents without having to load or otherwise access the intervening web pages labeled Page 2 and Page 2.2.

In certain exemplary menu-generating systems and methods, a main menu of the web site may be provided and displayed while any page is being browsed or viewed within the web site. The web sites may have several shortcuts in their link structures, and they may include more than one link leading to a particular web page. A main index page provided by the existing web sites may have more links than may be desirable or practical in the top level menu, including direct links to some of the web pages that may be placed further down in the link structure hierarchy. Also, the space available to display top-level links may be limited by the use of certain web browsers or small-screen displays, particularly when the menu data may be presented in the form of a menu bar.

An exemplary process for detecting the top-level links within a web site and generating a top-level menu is shown in FIG. 5C. In this exemplary process, a processor can receive a link structure associated with the web site from a crawler (step 231A). For example, all of the links located on the front page of the web site may then be detected (step 233A). All of the links located on the next level of web pages may then be detected (step 233A). Initially, these web pages may include those that are linked directly from the front page, and can be considered as second-level links associated with the web site link structure. Links that are detected on both the front page and the second level of the web site structure may be identified as top-level links. These top-level links may be ordered according to the number of times they are detected, and links that appear on a larger number of pages within the web site can optionally be listed towards the top of the menu data listing. A partial menu structure may then be filtered to eliminate duplicate occurrences of the links within the menu data being generated (step 232A). After filtering, a next-lower level of links that includes links contained within the web pages of the current level may be detected. These next-lower level links may also be filtered as described above. The process of detecting and filtering the next-lower level of links may be repeated until all pages within the web site have been accessed. The processor can then generate the menu data based on the link structure obtained using the exemplary process described above (step 231B).

The top-level menu of the exemplary web site link structure shown in FIG. 6A can include the top level links labeled Menu 1, Menu 2 and Menu 3. The top-level menu may also be displayed as the top row of menu items shown in FIG. 8A.

The size of a menu for a web site may be limited or truncated when obtaining menu data and generating the menu structure. The web sites may have thousands of web pages or more, and a navigational menu that can access each of these pages can be cumbersome and inconvenient. Also, it may be preferable to limit the number of menu items and associated links in a single sub-menu so that the hierarchal menus do not become too large and unwieldy to navigate or scroll through.

The menu size may be limited, e.g., by only including links internal to the web site (links within the same domain) when generating menu data, and ignoring links that lead to web pages outside of the web site domain. The menu size generated for a given web site may also be limited by specifying a cut-off level that corresponds to a maximum number of levels below the top level to crawl. The level or depth of a web page may be defined by the number of links present in the shortest path between the web page of interest and the top-level page. The exemplary process for generating the menu data shown in FIG. 5C may be stopped after filtering the links (step 232A) detected within the selected cut-off level, and then a final set of menu data can be generated (step 231B). Links on web pages that are at a deeper level than the selected cut-off level may be ignored, thus limiting the size of the navigational menus generated for the web site.

Alternatively, the size of the navigational menus generated may be reduced by limiting the total number of web pages and corresponding menu items to store as the menu data and/or to display for a certain web site. The size of the generated menus may also be limited by keeping only links to the web pages that have a predetermined page rank in the generated menu data. The page rank used in this exemplary process may be determined based at least in part on the level of the web page and/or the number of pages linking to the web page. Another option for limiting the size of the generated menus can include limiting the number of links and corresponding menu items associated with a web page to the number of menu items that can be clearly and/or conveniently displayed on the client or web browser. The links that are maintained within the menu data can be selected based on their relative ranking as described above. For large web sites, it may also be desirable to limit the number of menu items in the generated navigational menus to a number that may be updated within a reasonable timeframe.

FIG. 5D illustrates another exemplary process for generating a tree structure of menu data. This exemplary process is generally similar to the exemplary process shown in FIG. 5B, and further includes the generation of labels or names for menu items (step 233C). For example, the link text associated with a menu item or a portion thereof may be selected as a label for the corresponding menu item. The link text can include the text which appears together with the link on a client display, and which may be displayed to the user on a web page when it is viewed, e.g., via the web browser. The displayed link text may be underlined, and can also be displayed in a different color than the surrounding text. By performing a mouse click on displayed link text, the link associated with it can be activated. Examples of the link text may include the labels Menu 1, Menu 2 and Menu 3 shown on the exemplary web page in FIG. 7A.

Certain exemplary links may be accessed by clicking on a graphic element displayed on the web page, and may not have any link text associated with them. Examples thereof may include clickable buttons or other graphic elements such as, for example, a .JPG, .GIF or Flash (e.g. SWF) image that may further comprise text within the graphic element. It is to be understood that graphic elements may include static, sequenced and/or animated graphic elements, for example. Menu item labels may be generated for the links associated with graphic elements using, e.g., conventional character recognition of the displayed text within the graphic elements, if any such text is present. Alternatively, if no text is detected as part of the graphic element, or if the graphic element is not displayed, an ALT tag may be used as a menu item label for the link. If there is no ALT tag present, the title of the target page associated with the link, or a portion thereof, may be selected as the menu item label. If there is no title on the target web page, a headline or first line of text in the body of the target web page may be selected as a menu item label. If there is not text present on the target web page, the file name of the document may be used. The menu item label generated by any of the exemplary processes described above may be truncated as appropriate.

FIG. 5E illustrates yet another exemplary process for generating menu data based on the directory structure of the web site. Static HTML web sites and web sites that use a publishing system may include a hierarchal directory-based system to organize individual web pages within the site. Sections and subsections of the site may be organized by using path names that include directory and subdirectory names separated by a slash (“/”). An example of such a directory structure extending through three directory levels can be as follows:

http://www.web site.com/
http://www. web site.com/SPORTS/
http://www. web site.com/WEATHER/
http://www. web site.com/NEWS/
http://www. web site.com/NEWS/local/
http://www. web site.com/NEWS/national/
http://www. web site.com/NEWS/international/

In the exemplary process for generating the menu data shown in FIG. 5E, the processor may receive the full URL for some or all pages within a certain web site (step 234A). The processor may then detect and identify the directory structure based on the URLs, optionally remove duplicate links or subdirectories, and order the URLs in a sorted list (step 234B). Each item in the sorted list may represent a menu item, and the menu items can be ordered in a format similar to a directory tree. An example of a sorted directory tree can be as follows:

Main menu
SPORTS
WEATHER
NEWS
   local
   national
   international

The directory tree can then be converted into the menu data (step 234C). The first level directory can be used to generate top-level menu items, and the next level of the directory can be used to generate the next level of menu items, and so on, until the desired number of levels of the directory structure have been used to generate corresponding levels of menu items. If there is a large number of directory levels, the number of levels in the generated menu data may be truncated as described above. Optionally, menu data generated by using the directory structure as described above may be compared with and/or validated by menu data generated by any of the other processes described herein.

The menu data may be generated from an existing menu structure associated with a particular web site, if present. An example of such a process is shown in FIG. 5F. For example, a processor can receive full source code associated with a web site from the crawler (step 235A). The crawler may be configured to detect only the HTML code associated with the web pages, and to ignore scripts, tags and/or other specific elements to improve crawling efficiency. To detect an existing menu system, the full source code associated with the web site can be gathered by the crawler and provided to the processor. The processor may then detect an existing menu structure (step 235B) by detecting clusters of links, rows and columns of links in tables, bullet lists, Cascade Style Sheets that can format the link structure, javascript objects comprising links, etc., that may be contained within the provided source code. After detecting the menu structure, the processor may generate the corresponding menu data (step 235C).

An example of the navigational menus generated from the existing menu structures is shown in FIGS. 9A and 9B. The main menu of an exemplary web site is shown in FIG. 9A. This menu can be generated by the following exemplary source code through the use of a conventional stylesheet:

```
<DIV id=menyramme>
  <UL id=nav>
    <LI><A
    href=“ http://www.website.com/about.HTML”>About </A></LI>
    <LI><A
    href=“ http://www.website.com/products.HTML”>Products</A>
    <UL>
      <LI><A href=“
http://www.website.com/consulting.HTML”>Consulting</A>
      </LI>
      <LI><A href=“
http://www.website.com/statistics.HTML”>Statistics</A></LI>
      <LI><A
href=“http://www.website.com/online_marketing.HTML”>Online
marketing</A></LI>
      <LI><A href=“ http://www.website.com/virus.HTML”>Virus
protection</A>
      </LI>
    </UL>
    </LI>
    <LI><A
    href=“ http://www.website.com/links.HTML”>Links</A> </LI>
    <LI><A
    href=“ http://www.website.com/sitemap.HTML”>Sitemap</A>
</LI>
  </UL>
  </DIV>
```

If a stylesheet was not used, the menu may be displayed as an ordinary bullet list, such as the exemplary sorted directory tree provided above. The submenus associated with the exemplary source code listed above are shown in FIG. 9B. These submenus may be generated using stylesheets, javascript, or by other conventional way of generating hierarchal menus. Alternatively, menus may be displayed in a form of a sidebar which can include menu items, e.g., text and/or icons which may be associated with links, which can be arranged in a vertically-oriented region along a side of a display or browser window.

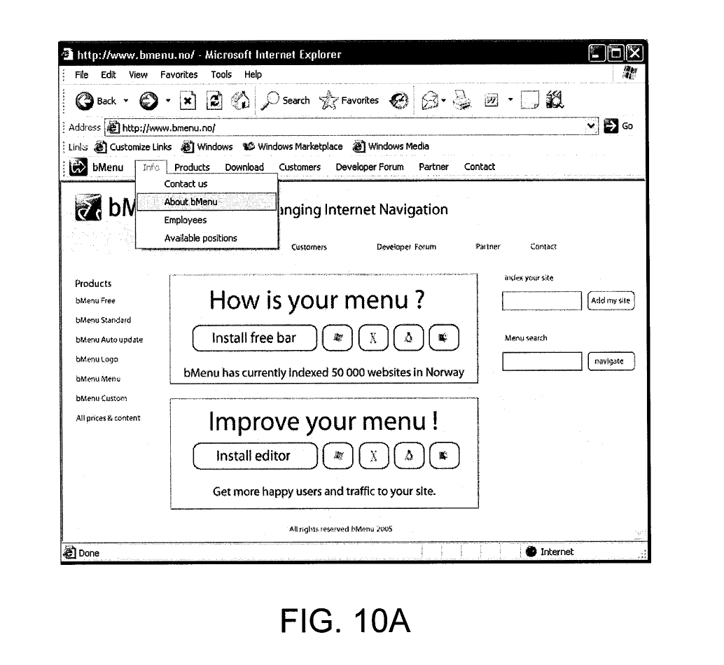

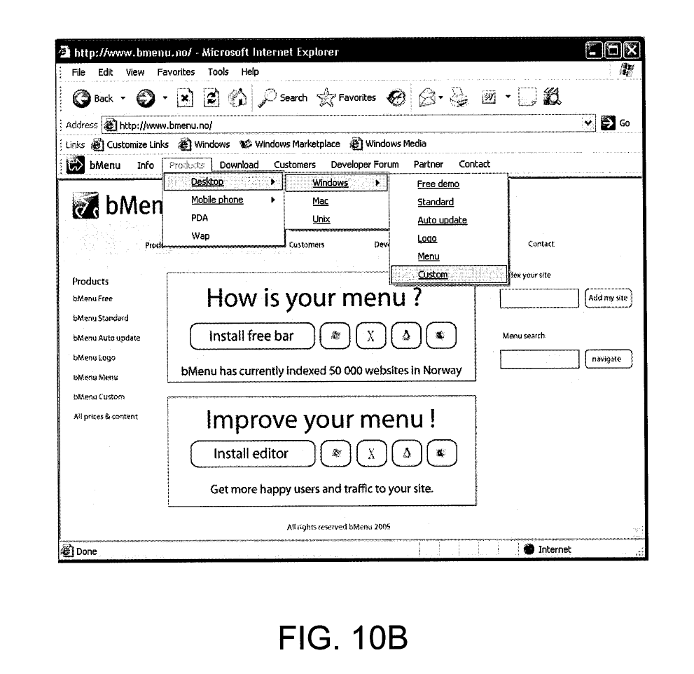

FIG. 10A shows an exemplary web site navigational menu that may be generated and displayed. Pre-selected top-level and/or sub-menu items may optionally be generated for web sites where a specific predefined content is detected. For example, an Info menu item can be automatically generated and associated with a link to a page containing certain content detected within a web site. By detecting the specific content or content having a predefined format on a web page within the web site, a standardized menu item can be generated which can link to the web page containing the specific content on any web site, if present. For example, a “Contact us” menu item may be provided for the web site, and linked to a web page containing contact information. To select the web page to link to from the “Contact us” menu item, variables such as the text “contact us,” phone number formats, e-mail formats, and the like may be provided to a content detection module. The module may then identify the web page where these words and formats occur most frequently, and may link this page to the menu item named “Contact us” under the Info menu. This exemplary procedure may be repeated for each web site accessed by the client.

Other types of content may also be linked to predefined menu items in the generated menus, such as the “Employees” and “Available positions” menu items shown under the Info menu item, as shown in FIG. 10A. To increase the accuracy of detected content, each variable used to identify specific content can be assigned a weighting factor. The weighting factor may also be affected by the location of a detected variable on a web page (e.g., the weighting factor may be larger if the detected content is located at or near the top of a web page), by other links or text detected on the web page, and the like.

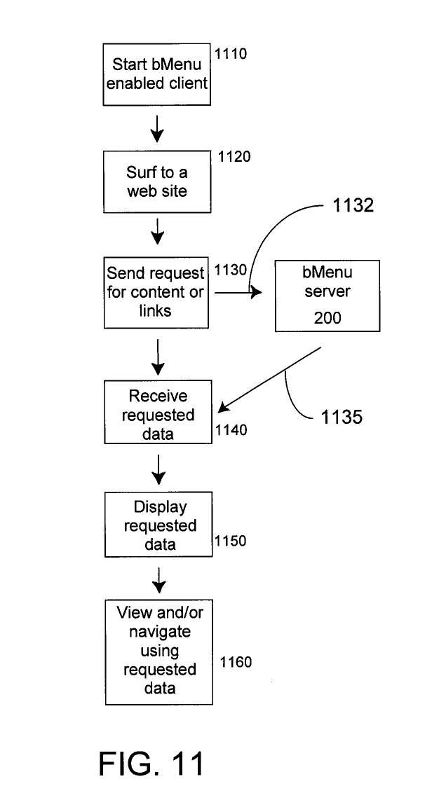

Systems and methods can also be provided which allow browsing of web pages on small-screen devices that includes display of either page links or page content. For example, FIG. 11 shows an exemplary client-side flowchart for providing small-screen browsing. A user can start a bMenu-enabled client (step 1110) such as, e.g., a browser capable of use on small-screen devices, for example, an Opera mini browser. The client can then connect to a web site or a particular web page (step 1120) associated with a URL entered or selected by the user.

The user can also provide a request for what content associated with the web page to load and/or display (step 1130). The requested content can be, e.g., page links or page content. A page link can include a link (e.g., a URL or computer code which can include a URL) which may identify a web page associated with the web site that includes the particular web page, a web page associated with another web site, and/or a particular location on a web page. Web content can include, e.g., textual material present on a web page such as, for example, articles, messages, image captions, etc., and/or graphical images, embedded video clips, etc. Page links can also have a form of embedded links which can include, e.g., certain portions of text and/or graphical images associated with the page content which may have a link associated with them.

The exemplary bMenu server 200 can receive the request 1132 and may generate the requested data 1135. The client can then receive the requested data 1135 (at step 1140) from the bMenu server 200.

The requested data 1135 can then be displayed by the client (step 1150), e.g., on a small-screen display. The requested data 1135 thus displayed can be viewed by the user and/or used to navigate to a further web page if page links are included in the requested data 1135 (step 1160). A new request for data associated with the further web page can be provided, e.g., by the user (step 1130).

Different content associated with the web page being viewed may also be requested (step 1130). For example, if a user first requests page content for a particular page (step 1130), a further request can then be made to display page links associated with the web page (step 1130). Alternatively, after viewing requested page links associated with a web page (step 1160), a user may also request page content associated with the same web page (step 1130).

An option can also be provided to load a particular web page using conventional techniques, in which both page links and page content may be displayed. Such an option may be processed for the particular web page without using the bMenu server 200.

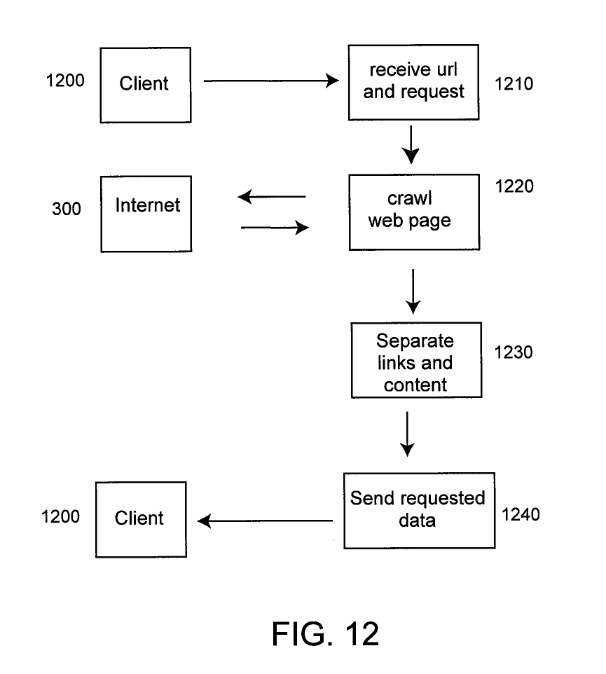

FIG. 12 shows an exemplary flowchart of server-related processes which may be performed to provide improved browsing on small-screen clients or devices. For example, a bMenu server 200 may receive a URL and a request from a client 1200 (step 1210). The request can be for page links and/or page content associated with the URL. The client may be, e.g., a small-screen device or other device capable of accessing, providing and/or displaying web pages. The crawler can then access the Internet 300 to “crawl” or obtain data from the web page associated with the URL (step 1220). The page links and page content associated with the web page may then be identified and separated (step 1230). The requested data may then be transmitted to the client 1200 (step 1240), and may be viewed and/or used, e.g., to navigate to other web pages or within a web page by the user.

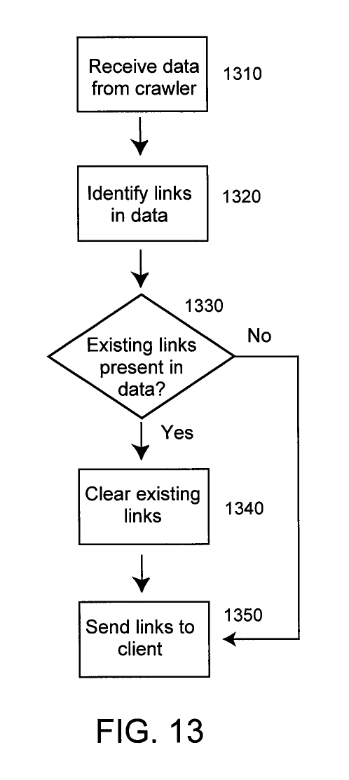

FIG. 13 shows an exemplary flow of a procedure which may be used for identifying and/or generating page links associated with a web page. The exemplary bMenu server 200 or another processor can receive data associated with a web page from a crawler or other data storage arrangement (step 1310). Links which may be present and/or accessible on a the web page can be identified or located (step 1320), for example, by scanning the source code associated with the web page for links. The server can then determine if other pages within the same website have been accessed or viewed recently, e.g., within the same browsing session or within a certain time period. This may be performed, e.g., by comparing previously requested URLs with the current URL and/or by matching the domain associated with the current web page to that of other web pages previously viewed. If other pages within the web site have been accessed recently, the server can also determine if existing links associated with these other pages are present within the data associated with the current web page (step 1330).

If other web pages associated with the same web site has been recently viewed or accessed, links which were found on previous web pages that are also identified on the current web page may be cleared or grayed out (step 1340). The remaining page links may then be sent to the client (step 1350) for viewing and/or to be used for navigating to further web pages. For example, if no web page associated with the same web site has been accessed recently, or no links on the current web page are the same as other links found on recently-accessed web pages, then the page links identified on the current web page may be sent directly to the client without clearing any links.

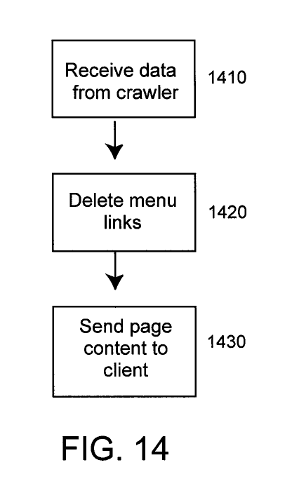

An exemplary flow diagram of a technique for separating out page content for small-screen browsing is shown in FIG. 14. Page content can include, e.g., text and/or images associated with a web page, and may exclude, for example, menus or separate links which may be present on a web page. To separate page content on a web page being accessed, the bMenu server 200 or another processor can receive data from a web crawler or other source such as, e.g., a memory storage device (step 1410). Menu links identified within the data can be deleted or, alternatively, stored in a separate file or data structure (step 1420). Text which may correspond to links that are embedded in the text can be kept as part of the page content, and such links may also be stored in a separate file or data structure. The requested page content, which can have separate links and/or menus removed, may be sent to the client (step 1430), e.g., for viewing on a display.

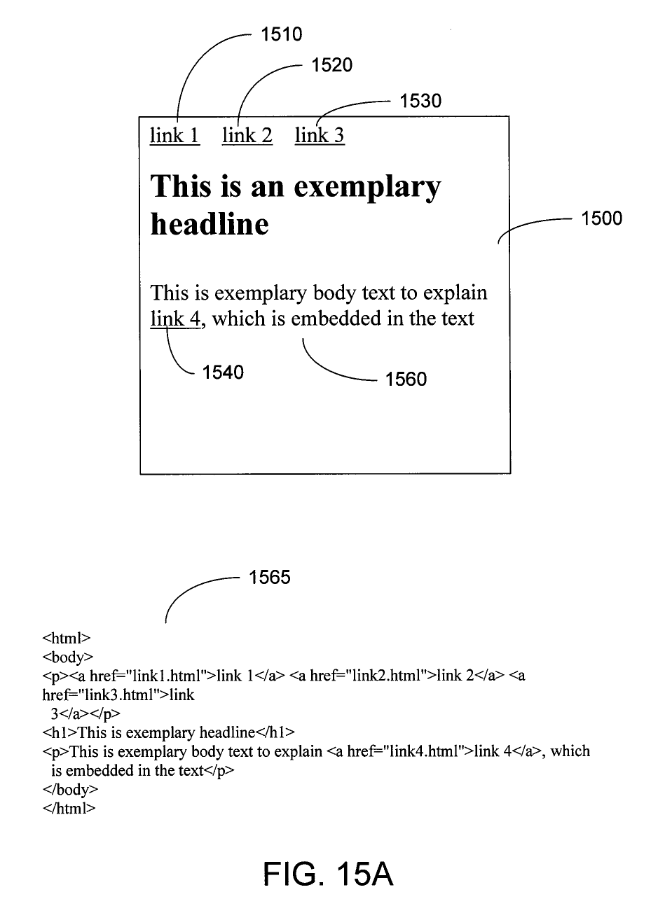

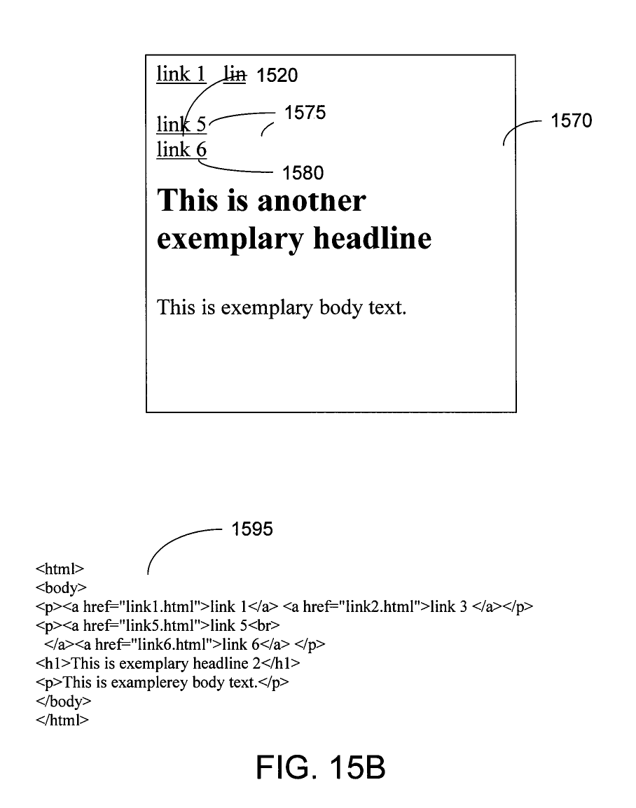

Examples of techniques described herein to identify and/or separate page links and page content are illustrated, e.g., in FIGS. 15A-17B. For example, FIG. 15A shows an exemplary web page 1500 and an exemplary code 1565 which can be used to generate the page 1500. If the web page 1500 and/or the associated code 1565 is scanned or examined for links, links link 1 1510, link 2 1520, link 3 1530 and link 4 1540 may be identified.

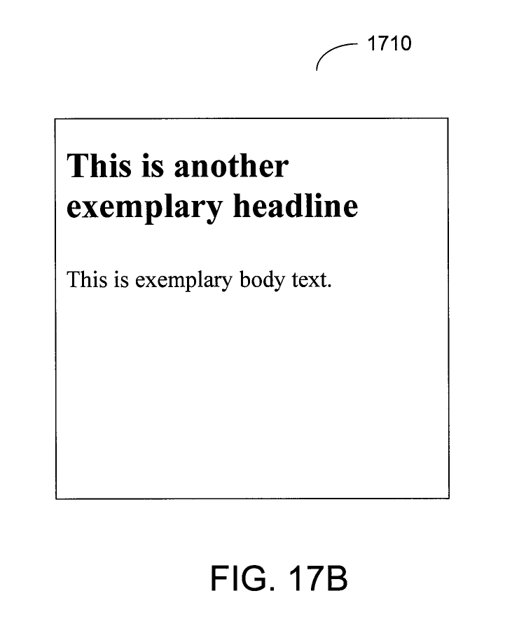

An example of an embedded link 1540 is also shown in FIG. 15A. The embedded link can be, e.g., a link which may have text before and/or after the link. Text associated with the embedded link text 1540, e.g., “link 4,” may be identified as part of the text 1560 which may be included in the page content. A display of filtered page content which may be identified with the exemplary web page 1500 is shown in an exemplary web page 1700 in FIG. 17A. This page content may not include separate links 1510-1530, and it can include the text associated with embedded link 1540. Identification of the page content can also include, for example, another filter procedure that can include long text strings associated with links as part of the page content. Such a filtering procedure can prevent, e.g., deletion of headlines which may be presented as links. Identification of page content can also include identifying text that is formatted using tags such as, e.g., H1, which may be associated with a headline, and including such text as part of the page content.

FIG. 15B shows an exemplary second web page 1570 and an exemplary code 1595 which can be used to generate the second page 1570. The second page 1570 can be associated with the same web site as web page 1500 shown in FIG. 15A. The links link 1 1510, link 2 1520, link 5 1575 and link 6 1580 may be identified on this web page 1570. A display of the filtered page content which may be identified with the exemplary web page 1570 is shown in an exemplary web page 1710 in FIG. 17B. This filtered page content may not include separate links 1510, 1530, 1575 or 1580, which can be present on the second web page 1570. Such a display of filtered page content can provide an improved browsing experience, e.g., by allowing a user to view the page content directly, without having to scroll past or otherwise navigate around any displayed page links. This can be particularly useful when viewing web pages which contain many page links.

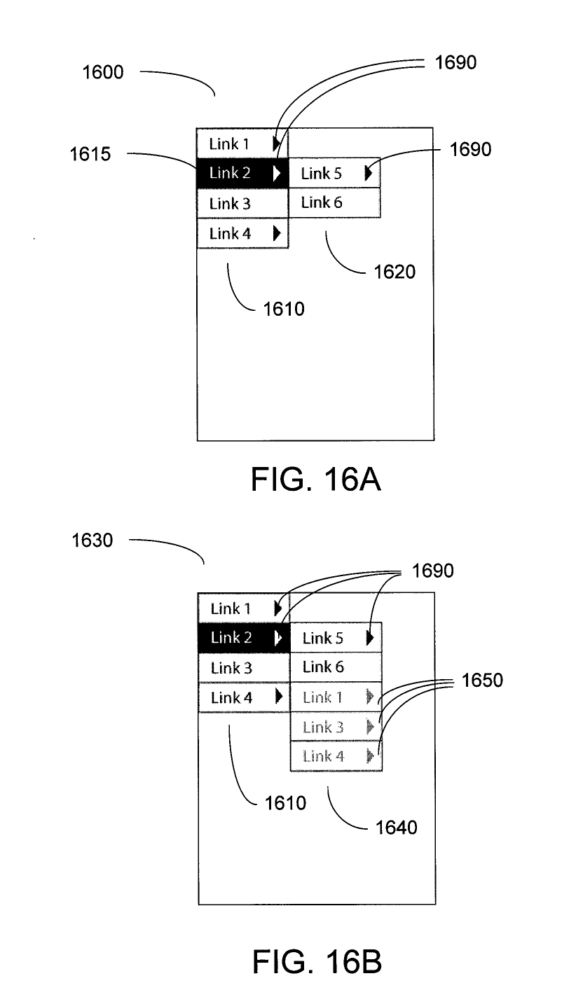

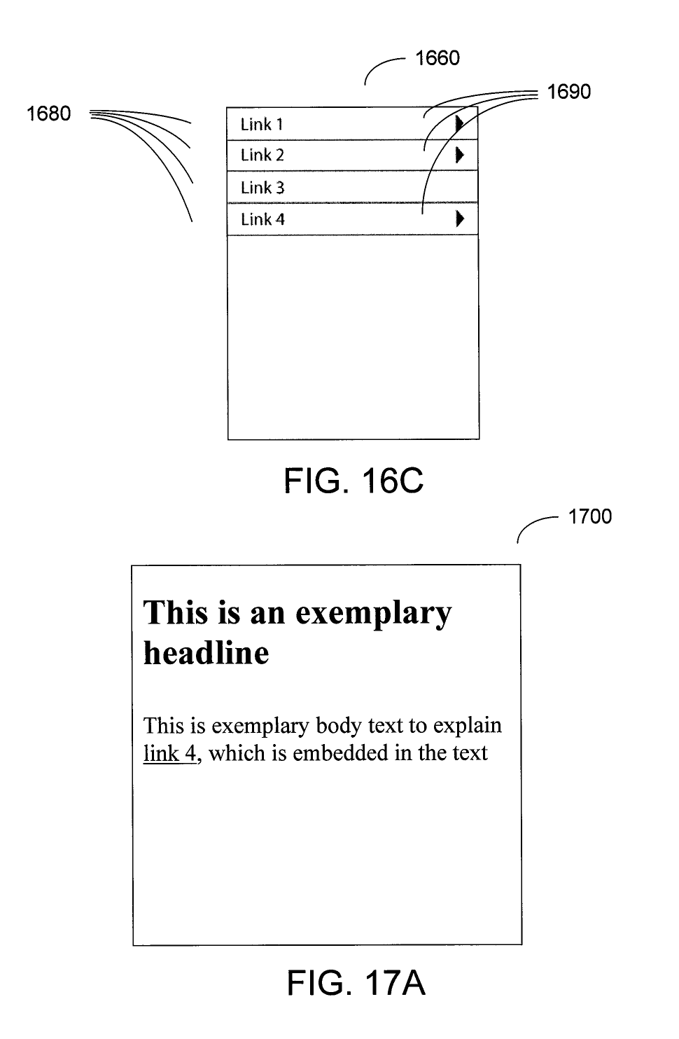

Page links may also be provided in a form of a menu structure. An exemplary menu structure 1600, which may be generated using links identified on web pages 1500 and 1570 in FIGS. 15A and 15B, is shown in FIG. 16A. The menu structure 1600 can be generated using exemplary link filtering processes described herein. For example, the leftmost column 1610 of the menu structure 1600 can provide menu items which can allow access to the links labeled “link 1” through “link 4” 1510-1540 associated with the web page 1500. The other menu column 1620 of this menu structure 1600 may contain the links labeled “link 5” 1575 and “link 6” 1580 on the second web page 1570 shown in FIG. 15B. The links labeled “link 1” 1510 and “link 3” 1530, which are present on the second web page 1570, may not have corresponding menu items on the menu column 1620 associated with this page. These two links are already present on another web page 1500 associated with the same web site, and thus these duplicate links can be filtered out to provide, e.g., a more convenient and/or manageable menu structure such as the one 1600 shown in FIG. 16A.

A further exemplary link filtering procedure can be used to remove, e.g., duplicate links which may appear on a single web page. For example, links to a particular web page or location on a web page may be present at two or more locations on a web page of interest. Such duplicate links may be associated with different labels. One or more such duplicate links on a web page can be removed using various criteria. For example, a duplicate link that appears closest to the top of a web page may be retained, and duplicates which may appear later or further down in the web page can be discarded or ignored. Alternatively, a duplicate link having a longer label, which may be more descriptive, can be kept, and duplicate links having shorter labels can be discarded or ignored. Certain duplicate links on a web page may also be retained when providing page link information and/or constructing menus. When one of the duplicate links is activated, other such duplicate links, e.g., can be grayed out in menus or other link display formats.

Certain types of links may also be stored, e.g., in a list or a database, and links on a web page that match such types of links may also be removed or filtered out when providing requested page links. Links that may be filtered out can include, e.g., links labeled “read more,” “page 2,” etc. A link filtering procedure may also be performed on more than one page associated with a web site, which can generate larger menus and/or improve the speed of providing menu structures associated with page links. Information describing filtered page links associated with a particular web page or web site may also be stored, e.g., on a server or in a memory storage arrangement, which can provide faster handling of repeated requests for such pages or sites.

Page links can be displayed by a browser in several ways. For example, the menu structure 1600 shown in FIG. 16A can provide an interface that allows a user to see two levels 1610, 1620 of filtered links on the screen at the same time. An alternative exemplary menu structure 1630 shown in FIG. 16B includes recurring links 1650 which are grayed out. An option can be provided for a user to display only new links, as shown in FIG. 16A, or all links as shown in FIG. 16B. A single-level menu structure may also be provided to display page links. The exemplary menu structure 1660 shown in FIG. 16C, for example, may display menu items associated with only links that are present on a current web page. When using this type of single-level menu structure, the entire menu can change when navigating to a different web page.

The generation and display of menu structures using page links, after filtering out page content, can facilitate navigation of web pages. A user may directly view and explore links present on web pages without having to read through page content and/or locate the page links on a page directly. Navigation of web pages can be performed in several ways using various forms of menu structures. For example, menu items corresponding to page links associated with a further page can be displayed, e.g., when a user moves to the right in the menu. A user who may have highlighted the menu item 1615 in FIG. 16A can then move a cursor or other indicator to the right, which can result in a second column of menu items 1620 being generated and/or displayed. The menu item 1615 labeled “link 2” can contain a link to the second web page 1570 shown in FIG. 15B. The menu items in the menu column 1620 can correspond to, e.g., links on the second web page 1570. Indicators such as, e.g., triangles 1690 shown in FIGS. 16A-16C can be provided in certain menu items to indicate that a further menu column may be associated with the menu item. Each menu column, such as the two columns 1610, 1620 shown in FIG. 16A, can correspond to links associated with a particular web page. Menu items which do not contain such a marker can indicate, e.g., that there are no further links associated with the web page corresponding to the menu item.

Various exemplary user options can also be provided to request, e.g., display of page content associated with a particular web page. For example, the leftmost column 1610 of the menu structure 1600 shown in FIG. 16 can provide menu items corresponding to the links 1510-1540 on the web page 1500 shown in FIG. 15A. The inverted menu item 1615 can represent a link to the second web page 1570 shown in FIG. 15B. Clicking on or selecting this menu item 1615 can send a request to load and display filtered page content for the second page 1570. The exemplary filtered content 1710 for the second web page 1570 is shown in FIG. 17B. A “switch” or “back” button, which can be provided in a form of, e.g., a physical button on a client, a displayed icon, or particular location on a display (for example, a corner of the display screen), can be used to return to a menu display from a display of page content, or vice-versa.

A user may also request display of either page content or page links using the exemplary menu structures shown in examples of FIGS. 16A-16C. For example, the user can highlight and select one of the menu item labels 1680 shown in FIG. 16C to request that page content from the web page associated with the menu item be obtained and displayed. Alternatively, the user may select one of the triangular indicators 1690 to send a request to generate and display a menu structure containing page links from the same web page. A “switch” or “back” button, as described herein, can also be used to switch between displaying page content and page links associated with a web page.

Various techniques described herein for generating menu structures and menu item labels can also be applied when using filtered data associated with a web page (which may, e.g., include page links and exclude page content). For example, concise and descriptive menu labels may be generated, and/or menu sizes may be truncated using the various procedures described herein.

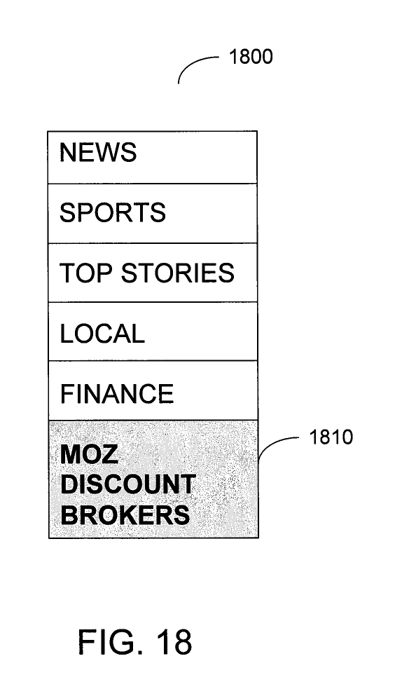

FIG. 18 shows an exemplary menu structure 1800 which includes an advertising menu item 1810 in accordance with exemplary embodiments of the present invention. Such advertising menu item 1810 can be provided as part of a hierarchal menu using the techniques described herein. It can include, e.g., an advertiser's name, logo or similar identifier in addition to the text and/or graphic elements discussed above, for example, which can provide advertising benefits by simply being placed before a user.

Alternatively, the advertising menu item 1810 can be selectable like other menu items, and can be associated with a hyperlink. Such hyperlink can point to, e.g., a web page or a pop-up advertisement associated with the advertisement.

Thus, menu-item advertisements such as the advertising menu item 1810 can provide relatively unobtrusive marketing exposure to users who are navigating using hierarchal menus, and can further provide a mechanism which allows users to quickly and easily navigate to advertisers' web sites by merely selecting such menu items.

Menu-item advertisements can be generated and/or displayed based on relevant keywords. This procedure for advertising can be referred to as “menu context advertising.” For example, keywords which may be used to generate menu-item advertisements may be based on characteristics of the menus themselves which are being navigated, and do not have to be dependent on particular search terms or other input provided by the user. Generating and displaying menu-item advertisements using such criteria can produce more relevant advertisements for users than conventional techniques based on user input, where arbitrary keywords can be taken out of the context and may have several different meanings.

Menu context advertising in accordance with exemplary embodiments of the present invention can provide improved targeting of advertisements because navigational menus, such as those described herein above, can be more specified. The keywords can be based on any desired portion of the menu structure, rather than, e.g., one or two words provided by a user.

In exemplary embodiments of the present invention, advertisers can purchase one or more specific keywords which can trigger generation and display of their advertisements as menu items. Alternatively, one or more categories such as ‘sports’ can be purchased, such that an advertiser's menu-item advertisements would be provided in all sports-related menus and submenus. In this manner, an advertiser can easily advertise in all menus which contain, e.g., sports-related topics on all web sites in a system by choosing only one category word. In contrast, conventional “pay per click” systems can require an advertiser to identify a large number of sports-related keywords in order to provide advertisements to a wide range of sports-related searches.

A menu-based advertising system and method in accordance with exemplary embodiments of the present invention can also be integrated in mobile menus or other menus which can be used on small-screen devices as described herein above. For example, menu-item advertisements can be shown in context with keywords that may be present in or associated with navigational menus provided on a mobile phone or other small-screen device. Because screen space can be scarce on such devices, it may be especially advantageous to provide menu-item advertisements that can be readily seen and accessed without using up a large amount of the display screen. Such menu-item advertisements for small screen devices can be generated in real time using, for example, exemplary small-screen bMenu techniques and systems as described herein above.

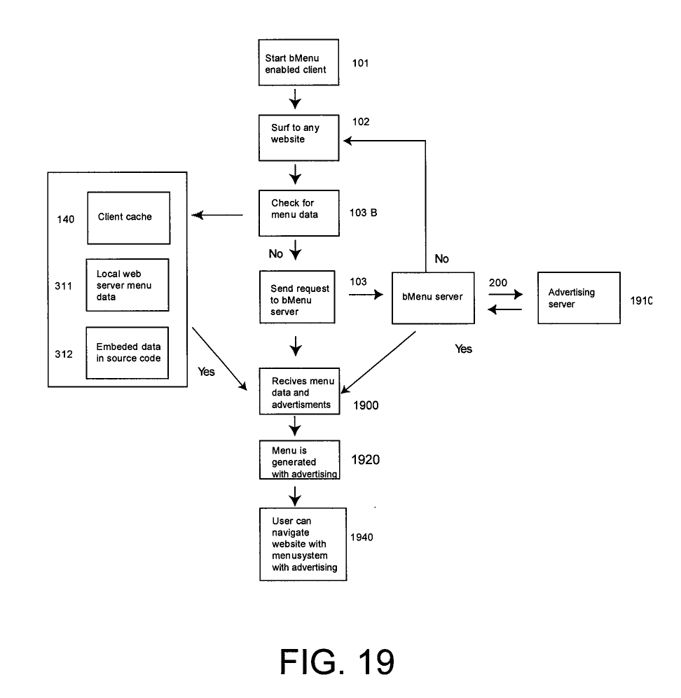

FIG. 19 shows an exemplary flow diagram for providing menu-item advertisements from a client perspective in accordance with exemplary embodiments of the present invention. For example, FIG. 19 includes several features illustrated in FIGS. 3A and 3B. The exemplary flow diagram in FIG. 19 also includes an advertising server 1910 which can be configured to receive a request for an advertisement from the exemplary bMenu server 200. It can also send, for example, information relating to one or more menu-item advertisements to the exemplary bMenu server 200. The client can receive menu data, including data for one or more menu-item advertisements, from the exemplary bMenu server 200 (step 1900). A menu can then be generated for display on the client that includes one or more menu-item advertisements (step 1920). A user can then navigate a web site using the generated menu system that includes one or more menu-item advertisements (step 1940). Such menu-item advertisements can display an advertiser's information, and/or they may provide selectable links that can direct the user to an advertiser's web site or which can reveal a larger advertising image.

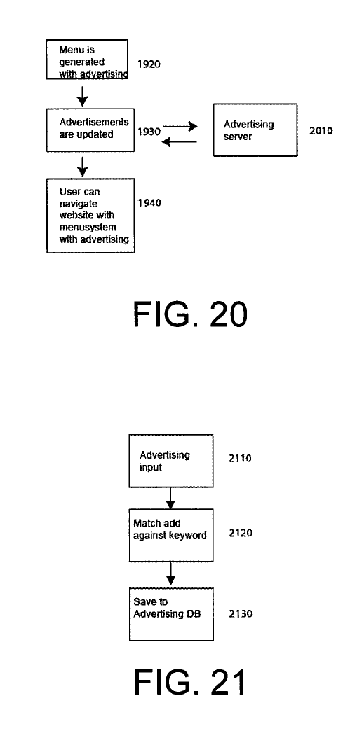

FIG. 20 shows a flow diagram from a client perspective of an exemplary update process according to the present invention, where menu-item advertisements can be updated independently of the rest of the menu. For example, a menu can be generated that includes one or more menu-item advertisements (step 1920). Advertisements provided in the menu-item advertisements can be updated (step 1930) by connecting to an advertising server 2010. An advertising file can be associated with each menu-item advertisement, and may include a timestamp or other data relating to an updating process. Updating of a menu-item advertisement (step 1930) can be performed based on such timestamp or other data using various criteria. For example, duration of menu-item advertisements can be extended for additional fees. Alternatively, an advertiser may wish to display different advertisements for the same menus or keywords so that the advertisement do not appear repetitive to a user.

The exemplary advertising server 2010 can determine if an update of any advertisements is required or based on preferred criteria such as, e.g., values contained in a timestamp associated with a menu-item advertisement. If an advertisement needs to be updated, data can be provided to the client for generating the new menu-item advertisement and menu-item advertisements can be updated (step 1930). The user can then navigate a web site using menus containing the updated menu-item advertisement (step 1940).

A flow diagram showing an exemplary procedure in accordance with exemplary embodiments of the present invention for determining which advertisement to be provided for displaying in a menu is shown in FIG. 21. For example, the exemplary advertising server can receive advertising input (step 2110). The advertising input can include, e.g., text to be displayed as an advertisement, one or more keywords which a menu-item advertisement can be linked up against, a reference title for the menu-item advertisement, a label for the menu-item advertisement, a visible URL to be displayed in the menu, and/or a target URL which can be activated if the menu-item advertisement is clicked on by the user. A visible URL can be used if a visible URL is too long to be displayed or if a different URL than the target URL is to be displayed in the menu-item advertisement. Graphical objects can also be provided for display in menu-item advertisements, or other content can be provided, e.g., in Vibrant Media's system.

Exemplary advertisement keywords can then be matched against keywords which may be present in the menu labels or, alternatively, on web pages for which menus are being generated (step 2120). This exemplary procedure can provide advertisements relevant to the information being accessed by the user for display in the navigational menus. Thus, it is possible to show the relevant advertisements according to the exemplary menu which is being navigated. The data described above that is associated with each exemplary advertisement that can be included in navigational menus can be saved in an advertising database (step 2130).

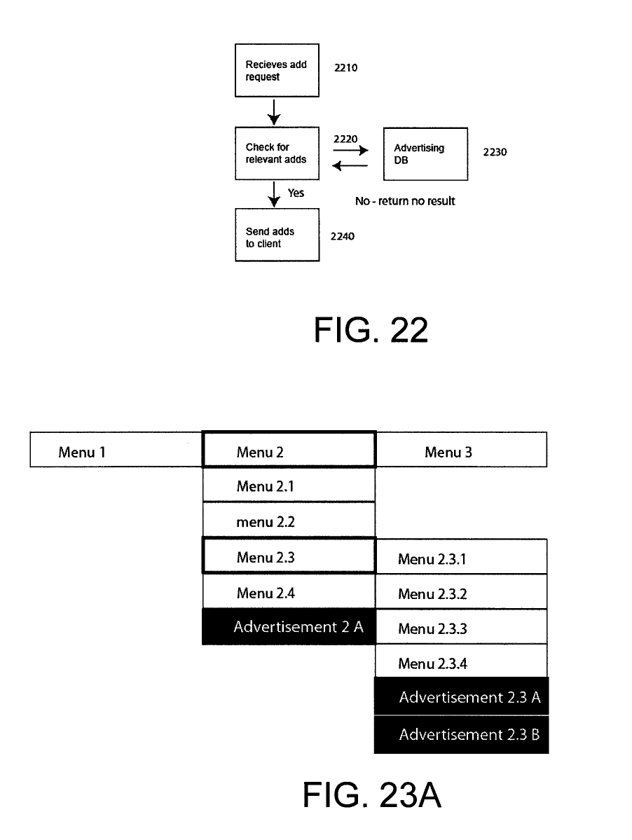

FIG. 22 is a flow diagram of an exemplary procedure for identifying and providing relevant advertisements for displaying in a menu. For example, a request for an advertisement can be received from a client device (step 2210). The exemplary request can be based on a variety of criteria. For example, a request can be generated when a new menu is being generated for a particular user. Alternatively, a request can be generated based on elapsed display time of an existing menu-item advertisement, which can in turn be based on, e.g., a timestamp or other data associated with an advertisement.

A search for relevant advertisements can be made based on such request (step 2220) by communicating the request to an advertising database 2230. If a relevant advertisement is identified, data associated with the advertisement can then be sent to the client (step 2240), and a menu-item advertisement can then be generated as part of a menu to be displayed on the client.

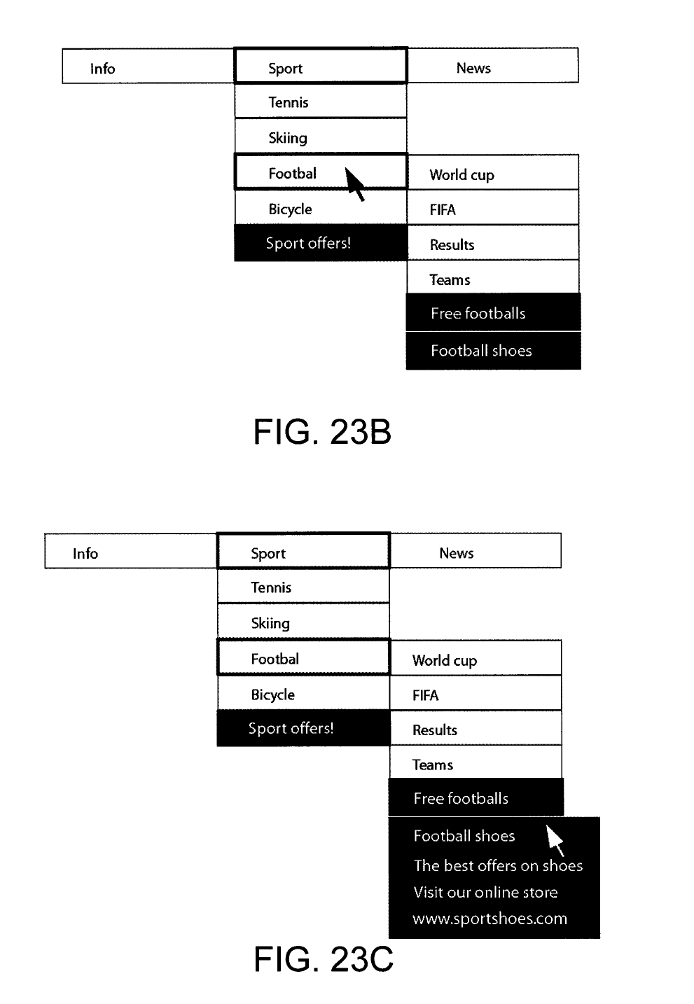

Menu-item advertisements in accordance with exemplary embodiments of the present invention can be displayed in navigational menus in the same or similar manner as the menu elements themselves as shown, e.g., in FIGS. 23A-23C. For example, FIG. 23A shows generic menu-item advertisements 2A, 2.3A and 2.3B which are displayed at the bottom of two levels of the hierarchal navigational menu.

FIG. 23B shows exemplary menu-item advertisements which are relevant to the sports topic being navigated, where the menu-item advertisements are again displayed at the bottom of two levels of the hierarchal navigational menu. For example, a primary keyword can be a keyword which a submenu is based on. A secondary keyword can be a menu label or other menu item identifier which is associated with the same submenu in which the menu-item advertisement appears. Either type of keyword can be used to select which advertisement to display in a given menu or submenu.

An advertiser can also have advertisements displayed as menu-item advertisements in a plurality of submenus which are subordinate to a particular menu category associated with the advertisement. For example, in FIG. 23B, ‘Sport’ can represent a keyword which has the menu-item advertisement “sport offers” connected to it. “Sport” can also be a category because it has submenus associated with it. When a category word is associated with certain advertisements, such advertisements can also be shown in submenus. In the menu shown in FIG. 23A, for example, choosing Menu 2 can cause the same advertisement to appear in both Advertisement 2A and Advertisement 2.3A.

As described herein above, exemplary menu-item advertisements in accordance with exemplary embodiments of the present invention can be displayed as, e.g., standard menu items which include a URL link and/or as a graphical element such as text and/or an image with no associated link. A link can be a text advertisement provided, e.g., by a system such as Yahoo! or Google Adwords. When using advertisements in a format similar to that of Google Adwords, for example, a headline of the advertisement can be shown in the menu as a label. A contrasting color scheme can also be provided, if desired, for one or more menu-item advertisements. For example, providing a different background color for menu-item advertisements can help to make them more visible, and can distinguish them form regular navigational menu items. Optionally, when a user provides a pointing graphic over or otherwise selects a menu-item advertisement, the item can expand to show an additional portion of the advertisement.

An advertisement in accordance with exemplary embodiments of the present invention can, e.g., be integrated in a menu or separated from the menu. In order to update an advertisement without loading the menu file again, data associated with advertisements can be loaded or obtained separately. Such exemplary data can be loaded directly from a server, including, e.g. a server of an external advertisement provider, or provided in a separate file to the client. The advertisements can then be updated separately and parsed into the menu by the client. Thus, each advertising menu item 1810 can be obtained directly from an external advertisement provider and loaded by the client.

Menu-item advertisements provided in accordance with exemplary embodiments of the present invention can be regulated, e.g., based on views and clicks. For example, fees charged for displaying such advertisements can be based, at least in part, on the historical number of views or clicks associated with an advertisement. Alternatively, higher fees can be paid by an advertiser to have its advertisements displayed in menus more frequently.

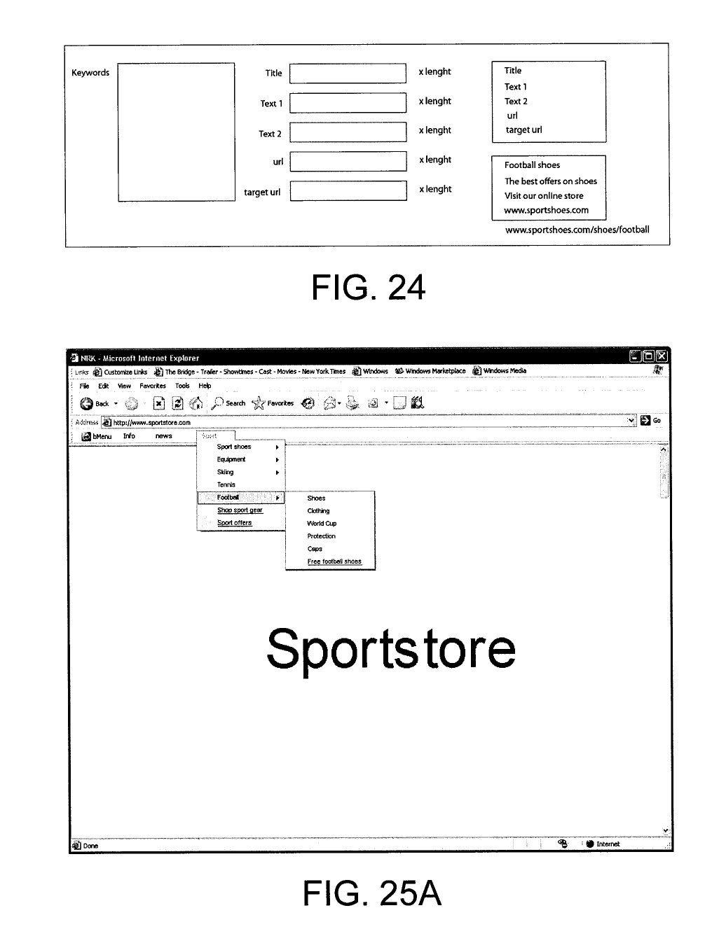

An exemplary interface for providing information which can be used to generate menu-item advertisements is shown in FIG. 24. Such information can include one or more keywords, a title for the advertisement, text and URLs to be associated with the advertisement, and optionally one or more preview screens for adjusting and viewing the layout of the menu-item advertisement.

Advertisers wishing to have their menu-item advertisements displayed can create an account, e.g., via an official website. Registration and payment details can be provided. Information relating to the desired menu-item advertisements can then be entered using, e.g., an interface such as that shown in FIG. 24.

A webmaster, another user or a computer arrangement (manually or automatically) can optionally set up a contextual menu-based advertisement system for a particular web site. Revenue can then be generated by the website by displaying menu-item advertisements to visitors of the web site. A portion of such revenue can be provided to the site owner. For example, each advertisement displayed and/or clicked on can be tracked and recorded to determine appropriate revenues to be paid by the advertiser.

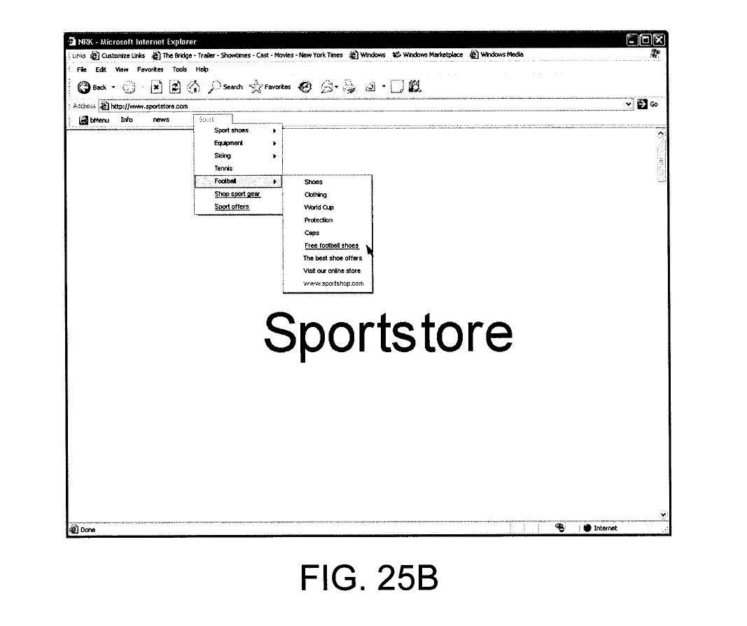

FIGS. 25A and 25B show exemplary menu-item advertisements similar to those shown in FIGS. 23B and 23C as they might appear to a user navigating an actual web page.

The foregoing merely illustrates the principles of the invention. Various modifications and alterations to the described embodiments will be apparent to those skilled in the art in view of the teachings herein. For example, web pages, page content, page links, etc., may be provided on and/or accessed via an intranet instead of or in addition to via the Internet. It will thus be appreciated that those skilled in the art will be able to devise numerous systems, arrangements and methods which, although not explicitly shown or described herein, embody the principles of the invention and are thus within the spirit and scope of the present invention. The detailed description, given by way of example, but not intended to limit the invention solely to the specific embodiments described, may best be understood in conjunction with the accompanying Figures. In addition, any patent, patent application and/or other publication cited herein is incorporated herein by reference in its entirety.

1. A computer-accessible medium having stored thereon computer executable instructions for displaying one or more menus to assist with navigation of a web site, wherein, when a computer arrangement executes instructions, the computer arrangement is configured to:
(a) receive first information from a client which is associated with the web site;
(b) obtain second information relating to a link structure of the web site;
(c) provide third information for generating at least one of a menu-based structure or a hierarchal structure as a function of the second information; and
(d) identify and/or separate web page links and web page content associated with the web site,
wherein the second information is at least one of generated or obtained independently from one or more processors associated with the web site, and wherein the at least one of the menu-based structure or the hierarchal structure comprises a plurality of items.

2. The computer-accessible medium of claim 1, wherein the at least one of a menu-based structure or a hierarchal structure includes at least one advertising menu item.

3. The computer-accessible medium of claim 2, wherein the at least one advertising menu item is capable of being at least one of generated or displayed in a navigational menu that has at least one of the menu-based structure or the hierarchal structure.

4. The computer-accessible medium of claim 3, wherein the computer arrangmenet is configured to facilitate an advertiser to be able to purchase one or more specific keywords or categories which allow for a triggering of a generation and/or display of a particular advertisement as the at least one advertising menu item.

5. The computer-accessible medium of claim 3, wherein the at least one advertising menu item is at least one of generated or displayed in the navigational menu based on one or more keywords which is provided in a menu label or on the web page for which the navigational menu is being generated and/or displayed.

6. The computer-accessible medium of claim 5, wherein the at least one advertising menu item is shown in the navigation menu in context with the one or more keywords that are provided in or associated with the navigational menu.

7. The computer-accessible medium of claim 3, wherein the computer arrangement is further configured to identify and provide a relevant advertisement to be displayed in a navigational menu.

8. The computer-accessible medium of claim 1, wherein the computer arrangement is configured to facilitate a user to provide a request for a particular content associated with the web page to at least one of load or display.

9. The computer-accessible medium of claim 1, wherein the computer arrangement is further configured to separate a particular page content for providing or displaying on a display of a limited screen device.

10. The computer-accessible medium of claim 1, wherein the at least one of the menu-based structure or the hierarchal structure is configured to be displayed on a mobile phone or a small screen device.

11. A method for displaying one or more menus to assist with navigation of a web site, wherein, when a computer arrangement executes instructions, the computer arrangement is configured to:
(a) receive first information from a client which is associated with the web site;
(b) obtain second information relating to a link structure of the web site;
(c) provide third information for generating at least one of a menu-based structure or a hierarchal structure as a function of the second information; and
(d) identify and/or separate web page links and web page content associated with the web site,
wherein the second information is at least one of generated or obtained independently from one or more processors associated with the web site, and wherein the at least one of the menu-based structure or the hierarchal structure comprises a plurality of items.

12. The method of claim 11, wherein the at least one of a menu-based structure or a hierarchal structure includes at least one advertising menu item.

13. The method of claim 12, wherein the at least one advertising menu item is capable of being generated and/or displayed in a navigational menu that has at least one of the menu-based structure or the hierarchal structure.

14. The method of claim 13, wherein the computer arrangmenet is configured to facilitate an advertiser to be able to purchase one or more specific keywords or categories which allow for a triggering of at least one of a generation or display of a particular advertisement as the at least one advertising menu item.

15. The method of claim 13, wherein the at least one advertising menu item is at least one of generated or displayed in the navigational menu based on one or more keywords which is provided in a menu label or on the web page for which the navigational menu is being generated and/or displayed.

16. The method of claim 15, wherein the at least one advertising menu item is shown in the navigation menu in context with the one or more keywords that are provided in or associated with the navigational menu.

17. The method of claim 13, wherein the computer arrangement is further configured to identify and provide a relevant advertisement to be displayed in a navigational menu.

18. The method of claim 11, wherein the computer arrangement is configured to facilitate a user to provide a request for a particular content associated with the web page to at least one of load or display.

19. The method of claim 11, wherein the computer arrangement is further configured to separate a particular page content for providing or displaying on a display of a limited screen device.

20. The method of claim 11, wherein the at least one of the menu-based structure or the hierarchal structure is configured to be displayed on a mobile phone or a small screen device.

21. A system for displaying one or more menus to assist with navigation of a web site, comprising:
a computer arrangement being capable of executing instructions, the computer arrangement being configured to:
(a) receive first information from a client which is associated with the web site;
(b) obtain second information relating to a link structure of the web site;
(c) provide third information for generating at least one of a menu-based structure or a hierarchal structure as a function of the second information; and
(d) identify and/or separate web page links and web page content associated with the web site,
wherein the second information is at least one of generated or obtained independently from one or more processors associated with the web site, and wherein the at least one of the menu-based structure or the hierarchal structure comprises a plurality of items.

22. The system of claim 21, wherein the at least one of a menu-based structure or a hierarchal structure includes at least one advertising menu item.

23. The system of claim 22, wherein the at least one advertising menu item is capable of being generated and/or displayed in a navigational menu that has at least one of the menu-based structure or the hierarchal structure.
